SEQUENCE LISTING (10 sequences)

SEQ ID NO: 1 - DNA, 20 bp, Artificial Sequence
  Bit # 1 (“0”)
ggttcacgttgatagtatgc

SEQ ID NO: 2 - DNA, 20 bp, Artificial Sequence
  Bit # 1 (“1”)
ggttcacgtgtatagtatgc

SEQ ID NO: 3 - DNA, 20 bp, Artificial Sequence
  Bit # 2 (“0”)
tagatgcgtagccctgctat

SEQ ID NO: 4 - DNA, 20 bp, Artificial Sequence
  Bit # 2 (“1”)
tagatgcgttcccctgctat

SEQ ID NO: 5 - DNA, 20 bp, Artificial Sequence
  Bit # 3 (“0”)
tgagcttgaccggtatccca

SEQ ID NO: 6 - DNA, 20 bp, Artificial Sequence
  Bit # 3 (“1”)
tgagcttgaatggtatccca

SEQ ID NO: 7 - DNA, 20 bp, Artificial Sequence
  Bit # 4 (“0”)
aaaggcctgcgcatggcgct

SEQ ID NO: 8 - DNA, 20 bp, Artificial Sequence
  Bit # 4 (“1”)
aaaggcctgttcatggcgct

SEQ ID NO: 9 - DNA, 20 bp, Artificial Sequence
  Bit # 5 (“0”)
gacgaaagctatgccttttc

SEQ ID NO: 10 - DNA, 20 bp, Artificial Sequence
  Bit # 5 (“1”)
gacgaaagcggtgccttttc

(19) United States
(12) Patent Application Publication
(10) Pub. No.: US 2010/0285983 A1
(43) Pub. Date: Nov. 11, 2010

(54) OPTICAL DISCS FOR ANALYZING BIOMOLECULES

(75) Inventors: Preben Lexow, Oslo (NO); Jonas Rundquist, Stockholm (SE); Anders Hanning, Sollentuna (SE); Robert James Longman, Hertfordshire (GB); Richard Anthony Lione, Cambridgeshire (GB); Jitka Brynjolffssen, Hertfordshire (GB)

Correspondence Address: SALIWANCHIK LLOYD & SALIWANCHIK;A PROFESSIONAL ASSOCIATION, PO Box 142950, GAINESVILLE, FL, 32614, US

(73) Assignee: Lingvitae Holding AS, Oslo (NO)

(21) Appl. No.: 12/664,390

(22) PCT Filed: Jun. 12, 2008
(86) PCT No.: PCT/EP08/57439

§ 371 Date: Jun. 30, 2010

(30) Foreign Application Priority Data
Jun. 12, 2007 (GB) 0711318.6
Sep. 25, 2007 (GB) 0718715.6

(51) Int. Cl. C40B 30/04; C40B 40/06; C40B 50/00

(52) U.S. Cl. 506/9; 506/16; 506/23

(57) ABSTRACT

The present invention describes optical discs on which polymer molecules can be analyzed. There is a method for determining a plurality of characteristics of a target molecule, the target molecule being localized on an optical substrate comprising pits and lands, comprising the steps of:
(i) carrying out a series of reactions to interrogate different defined characteristics of the target molecule, wherein each of the reactions occurs in a distinct pit;
(ii) treating the optical substrate to modify either those pits where a reaction has occurred, or alternatively, those pits where a reaction has not occurred, to alter the reflective characteristics of the pits; and
(iii) measuring reflectivity within the pits, to thereby determine different characteristics of the target.

### FIELD OF THE INVENTION

This invention relates to methods and apparatus for encoding information on the characteristics of a polymer or other molecules onto an optically readable substrate. It is particularly useful for encoding polynucleotide sequence information onto an optical disc.

### BACKGROUND TO THE INVENTION

Advances in the study of molecules have been led, in part, by improvement in technologies used to characterise the molecules or their biological reactions. In particular, the study of the nucleic acids DNA and RNA has benefited from developing technologies used for sequence analysis and the study of hybridisation events.

The development of genomics and proteomics as a viable method of studying biological molecules has occurred concurrently with the development of increasingly miniaturised analysis and detection equipment and procedures, which allow a large number of samples to be assayed simultaneously. The micro-array is the best known example of such a “high-throughput” technique.

Optical discs have also been developed for rapid multiplexed detection and characterisation of biological and chemical samples. This technique adapts the technology developed in the field of audio and video optical discs, such as compact discs and DVDs. A molecule of interest (the analyte) is placed on or in the optical disc and a light beam, most commonly a laser, is focussed onto the surface of the disc. A detector then detects light reflected from or transmitted through the optical disc. Analysis of the detected light provides information on the analyte. This has been referred to as “lab on a disc” technology. Examples are described in WO-A-96/09548, WO-A-98/12559 and U.S. Pat. No. 6,760,298. High-throughput micro-fluidic processing of protein samples on a compact disc is described in Gustafson et al, Analytical Chemistry, Vol. 76: Issue 2 (253-502), 2004.

However, conventional optical disc technology was not designed for use in biological and chemical assays. The majority of currently available techniques to analyse biological molecules using an optical disc attempt to perform biological and chemical procedures on or in optical discs. The optical disc may contain information relating to the assay but acts primarily as a convenient support for the biological assay; the optical disc and biological assay technologies remain essentially separate.

WO99/35499 (Remacle) describes the use of optical discs as a substrate surface for the detection of a target molecule. The discs are provided with non-cleavable capture molecules bound on an area of the disc. The capture molecules provide the means to isolate one or more target molecules from a sample, with detection of binding occurring by the use of a laser to measure changes in laser reflection. The change in laser reflection may be due directly to the binding of the target molecule, or may be caused by a localised corrosive effect at the site of binding. The methods disclosed in the publication only allow limited information to be obtained from the reaction. A binding event is detected but provides no information on the characteristics of the target, other than the knowledge that it has affinity for the binding ligand.

According to WO99/35499, the interaction between a target molecule and its affinity partner results in an impression (mound) being created on the substrate surface, which is detected by a laser beam and converted into a binary signal. The binding reaction can occur within pre-formed cavities in the substrate or on a strip of plastic fixed upon the top surface of the substrate. The laser beam is either focussed on the top surface of the substrate and light reflected off a highly reflective layer to a detector (reflective detection), or the laser beam is focussed on the underneath of the substrate with the light passing through a semi-reflective material and a detector used to capture and measure light that passes through the substrate (light transmission). Given that the reactions occur in relatively large areas of the disc, the resolution is relatively low.

US2007/0031856 (Hong) describes the fabrication and use of biodisc microarrays. The biodisc is a CD-type optical disc onto which small oligonucleotide probes are disposed. The oligonucleotides are micro-fabricated in situ or manufactured using a technique termed spin-on-and-peel. The fabricated microarrays are used to detect hybridisation events using fluoroluminescent tags present on the target polynucleotides. Although US2007/0031856 shows that depositing polynucleotides within pits in a CD-type disc is possible, the requirement for fluoroluminescent tags for detection limits the utility of the biodiscs as fluors are subject to quenching. In addition, fluorescent signals tend to be weak and a filter and separate detector are normally required.

U.S. Pat. No. 670,298 (Worthington) describes the preparation of optical discs used for detecting analytes. The discs are manufactured with multiple data layers which form cavities for receiving analytes. Biological or chemical reactions can be performed in the analyte sections and used to generate optical effects which are detected by laser light. The reactions carried out in the optical disc do not modify the structural characteristics of the discs.

U.S. Pat. No. 6,342,349 (Virtanen) describes optical disc-based devices in which analyte-specific signal elements are disposed. The signal elements can be immobilised to the optical disc and used to capture target analytes. The signal responsive moiety acts to reflect, scatter and absorb incident light if the target analyte is bound. Therefore, the publication describes a method for analyte detection based on the presence of a signal moiety localised at a defined position on the optical disc. The light (laser beam) used to detect the moiety is directed onto the top surface of the optical disc and the reflected light is detected in a detector positioned above the optical disc.

Although each of these publications describe useful analyte detection techniques using optical discs, there is still a need for improved methods for detecting biological reaction using high density optical discs, where particular characteristics of a biological molecule can be converted into binary signals for subsequent identification.

WO-A-04/094664 and WO-A-00/39333 describe techniques for the formulation of a “design polymer”. Design polymers are polymeric sequences, usually DNA, which encode information regarding a target polymer. The design polymer will usually contain a series of monomer sequences which represents a single monomer on the original target sequence. The original sequence is now said to be “magnified”. In this way, a “modified” sequence is obtained which can be interrogated with greater discrimination than the monomers of the original target. For example, using a defined sequence of monomers to represent a single monomer on the target allows the user to more accurately determine the sequence of the target, as any mis-sequencing of the design polymer is more clearly detectable.

Although design polymers are very useful, there are still challenges to provide techniques for the eventual read-out of the design polymer sequence.

### SUMMARY OF THE INVENTION

The present invention is based on the realisation that an optically readable substrate can be modified to encode information on the characteristics of an anlyte molecule e.g. a polymer. The modified substrate can then be used in apparatus to decode the information on the substrate. The present invention is therefore particularly suitable for determining the sequence of a polymer, whereby the sequence of the polymer is encoded onto the substrate, for subsequent decoding. In preferred embodiments, the invention provides optical discs which can be used with single pit resolution to encode information on the biological molecules on the optical disc.

According to a first aspect of the invention, an optically readable substrate comprises a transparent solid substrate, the upper surface of which has a reflective material disposed thereon, and a layer of a compound which coats the top surface of the reflective material. The compound is organic or inorganic and can be ablated by laser light to create pits.

According to a second aspect of the invention, an optical substrate comprises a reflective layer and a series of pits and lands, wherein one or more pits comprise a polymer molecule with an affinity partner bound thereto, the pits with the affinity partner having a material positioned at or within each pit, characterised in that the pits which do not have the affinity partner do not have a reflective layer.

According to a third aspect of the invention, an optical substrate comprises a series of pits and lands, wherein one or more pits comprise a polymer molecule with an affinity partner bound thereto, wherein the pits with the affinity partner have a material positioned at or within each pit, characterised in that the optical substrate does not comprise a reflective layer at the base of the pits.

According to a fourth aspect of the invention, an optical substrate comprises a reflective layer and a series of pits and lands, wherein one or more pits comprise a first polynucleotide with a second polynucleotide bound thereto, the pits with the first and second polynucleotides having a material positioned at or within the pits, characterised in that the first polynucleotide comprises a series of sequence units, each unit comprising a plurality of nucleotide sequences representing a specific characteristic.

According to a fifth aspect of the invention, an optically readable substrate comprises a polynucleotide localised on a discrete area of the substrate in a substantially linear conformation, wherein a plurality of oligonucleotide probes are attached at distinct regions to the polynucleotide.

According to a sixth aspect of the invention, an optically readable substrate comprises a reflective layer, the substrate further comprising grooves on the substrate surface having functionalised nanoparticles attached therein.

According to a seventh aspect of the invention, there id a method for determining a plurality of characteristics of a target molecule, said target being localised on an optical substrate comprising pits and lands, the method comprising the steps of:

(i) carrying out a series of reactions to interrogate different defined characteristics of the target molecule, wherein each of said reactions occurs in a distinct pit;

(ii) treating the optical substrate to modify either those pits where a reaction has occurred, or alternatively, those pits where a reaction has not occurred, to alter the reflective characteristics of the pits; and

(iii) measuring reflectivity within the pits, to thereby determine different characteristics of the target.

According to an eighth aspect of the present invention, a method for determining a series of characteristics of a molecule comprises reacting the molecule on or at the surface of an optically readable substrate having a reflective layer and disrupting the reflective layer at one or more sites of reaction, to thereby encode one or more identifiable signals on the substrate which represents the reactive characteristic of the molecule.

According to a ninth aspect of the invention, a method for encoding information on the characteristics of a polymer onto an optically readable substrate having a reflective layer, comprises the steps of:
i) localising a polymer onto a discrete area of the substrate
ii) interrogating the polymer at discrete sites; and
iii) treating the substrate such that the reflective layer is altered or disrupted at the sites of interrogation, or alternatively, at sites where no interrogation occurs.

Altering or disrupting the reflective layer at the sites of reaction/interrogation allows the substrate to “encode” the information revealed about the molecule/polymer. Analysis of the reflective layer in a subsequent step will determine (decode) the sites of reaction/interrogation providing useful information on the characteristics of the molecule, e.g. the sequence of the polymer.

According to a tenth aspect of the invention a method for analysing the sequence of a polynucleotide, comprises:

i) providing an optically readable substrate having a reflective layer, the substrate having bound thereto, at distinct sites, a series of oligonucleotide probes of defined sequence, each representing a sequence of the polynucleotide;

ii) hybridising the polynucleotide to the oligonucleotide probes;

iii) attaching a label to those oligonucleotides which are fully complementary to the polynucleotide, the label being capable of altering or degrading the reflective layer, or otherwise exposing the reflective layer for alteration or degradation; and

iv) analysing the substrate to reveal the arrangement of alteration or degradation, and thereby the sequence of the polynucleotide.

According to an eleventh aspect of the invention a method for storing information on the characteristics of a polymer comprises encoding an optically readable substrate with a series of optically readable structures which, together, identify a plurality of characteristics of the polymer.

According to a twelfth aspect of the invention, there is a method for encoding information relating to a polymer onto an optically readable substrate which comprises a reflective layer, the method comprising localising the polymer on or next to the substrate surface; localising a nanoparticle at that part of the substrate surface that corresponds to a defined part of the polymer; bringing the nanoparticle into contact with the surface of the substrate under conditions which promote a reaction to alter or disrupt the surface at a discrete site, thereby either altering or disrupting the reflective layer, or exposing the reflective layer for a subsequent reaction to alter or disrupt the reflective at the discrete site, thereby encoding the substrate with information on the defined part of the polymer.

According to a thirteenth aspect of the invention, there is a method for aligning a polymer molecule on a substrate surface, said surface comprising one or more radial grooves, comprising attaching a terminal region of the polymer to a groove; rotating the substrate about an axis at a predetermined speed, whereby the substrate rotates into and out of a liquid, wherein the polymer is aligned within the groove as it rotates out of the liquid.

According to a fourteenth aspect of the present invention, a method for analysing the sequence of a polynucleotide comprises:

i) providing an optically readable substrate having a reflective layer, the substrate having bound thereto, at distinct sites, a series of oligonucleotides of defined sequence, each representing a putative sequence of the polynucleotide.

ii) reacting the polynucleotide with two or more of the oligonucleotides;

iii) attaching a label to those oligonucleotides that react with the polynucleotide, the label being capable of altering the reflective layer, or otherwise exposing the reflective layer for subsequent alteration; and

iv) analysing the substrate to reveal the arrangement of alteration, and thereby two or more sequences of the polynucleotide.

According to a fifteenth aspect of the invention, there is an optically readable substrate, having a polynucleotide attached thereto, the polynucleotide having a series of defined sequence units each of which has at least two nucleotides.

According to a sixteenth aspect of the invention, a method for the production of an optical disc for encoding biological information comprises:

(i) obtaining an optical substrate having
(a) an optically transparent substrate layer;
(b) a reflective material disposed in a layer on the top surface of the transparent substrate; and
(c) a compound layer disposed on top of the reflective layer,

(ii) ablating predefined pits in the compound layer in a defined pattern to expose the reflective material within the pits.

### DESCRIPTION OF THE DRAWINGS

The invention is described with reference to the following drawings, wherein:

FIG. 1 illustrates separate sequence units, representing a binary code, that can be incorporated into a design polymer sequence, and which is to be encoded onto a substrate;

FIG. 2 illustrates an embodiment of the present invention, whereby an amplified polynucleotide sequence is in contact with a plurality of oligonucleotide probes present on the substrate surface;

FIGS. 3 and 4 illustrate the degradation of the reflective layer on the substrate by a label;

FIG. 5 illustrates a design polymer construct to be used in the invention;

FIG. 6 illustrates the manufacture of the optical substrates according to the invention;

FIG. 7 illustrates the molecular combing technique used to adsorb a polynucleotide onto the surface of a disc;

FIG. 8 illustrates physical characteristics of an optical disc for use in the present invention;

FIGS. 9 to 11 illustrate the localisation of nanoparticles to indentations present in grooves of the optical substrate;

FIGS. 12 to 14 illustrate the localisation of nanoparticles within specific areas of the optical substrate and the formation of self-assembled monolayers at specific regions on the optical substrate surface;

FIG. 15 illustrates different configurations on the optical substrate surface, used to anchor polynucleotides to the substrate for subsequent combing;

FIG. 16 illustrates three configurations of the optical disc having (a) wet-etched reflective layer after deposition of blocking layer (silver enhancement) (b) no wet-etching and (c) etching prior to analysis;

FIG. 17 illustrates the pit resolution achieved by measuring reflectance of pits that are blocked and then etched;

FIG. 18 illustrates the pit resolution achieved by measuring reflectance of pits that have not been etched;

FIG. 19 illustrates the pit resolution achieved by measuring reflectance of pits etched prior to analysis;

FIG. 20 shows AFM topologies of optical discs according to the invention;

FIG. 21 shows silver enhancement achieved on an optical disc;

FIG. 22 illustrates the land and pit profile prior to etching and after etching;

FIG. 23 shows the disc drive SUM signal-vs-time for a single groove trace on a disc;

FIG. 24 shoes the disc drive SUM signal-vs-time for a single groove trace on a disc, with a dingle pit signal from one groove with pits blocked with silver and with intact reflector;

FIG. 25 shows the scope trace for disc drive detector SUM signal along one track with an area covered with silver and an area not covered with silver;

FIG. 26 shows the scope trace for disc drive detector SUM signal along one track with an area covered with silver; and

FIG. 27 shows the disc drive SUM signal-vs-time for a single groove trace on a disc.

### DETAILED DESCRIPTION OF THE INVENTION

The invention allows the characteristics of a molecule to be encoded on an optical substrate. The encoded information can then be decoded (read) in a later step. In one embodiment encoding is carried out by making use of a reflective layer on the substrate, which can be disrupted in a defined manner depending on the characteristic of the molecule under study. Disrupting the reflective layer creates a readable optical substrate. In an alternative embodiment, the molecule is analysed within pits on the optical substrate, and the pits are modified depending on whether a reaction has occurred or not. Discrimination between the pits is therefore possible and so single pit resolution can be achieved. This provides the ability to generate binary data, based on the read-out of the individual pits.

The invention preferably allows information on the characteristics of a polymer molecule to be encoded onto an optically-readable substrate. In its simplest form, the invention allows a polymer molecule to be interrogated at the substrate surface, such that specific characteristics of the polymer are encoded onto the substrate by modifying the substrate, for example by altering or disrupting the reflective surface of the substrate at those sites on the polymer where interrogation occurs. The characteristics of the polymer can then be identified by using conventional or modified apparatus to ‘read’ the substrate surface. The arrangement of the modifications to the substrate indicates the characteristics of the polymer.

This method is particularly useful for encoding the sequence of a polymer onto a substrate. Once the information is encoded onto the optically-readable substrate, standard optical read-out procedures can be used to read the information. Both the methods and apparatus described herein are part of the invention.

The present invention can be used to analyse the characteristics of a molecule. For example, the present invention can be used to determine the type of molecule by its binding characteristics to one or more affinity molecules localised on the substrate surface.

The present invention is particularly useful to determine specific sequences present in a polynucleotide. This will be of use in analysing polynucleotides which have been designed to represent specific characteristics on a polymer or polynucleotide. For example, the polynucleotide under study may be a polynucleotide as defined in PCT/GB06/00825, the content of which is incorporated herein by reference. However, the present invention can also be used to determine the sequence of conventional DNA molecules, or to detect the presence of a DNA molecule in an assay-based system.

As used herein, the term “optically-readable substrate” includes any material that may be scanned by a light beam to allow analysis of the substrate. It will be apparent to one skilled in the art that reflected or transmitted light can be detected. The preferred substrate is an “optical disc”. The term “optical disc” is well known in the art to refer to a storage device that is read by a laser. The most common optical discs are compact discs (CDs) and digital video discs (DVDs). New developments in optical disc technology are increasing the capacity of this storage medium, for example high definition digital video disc (HD-DVD). Any of these optical discs, or any other type of optical disc, may be used in the current invention. As used herein, the term “optical characteristics” of the substrate refers to the effect that the substrate has on a beam of light that is transmitted through, or reflected from, the substrate. A change in the optical characteristic will usually result in a change in the signal generated on reading the substrate.

The structure of an optical disc will be apparent to one skilled in the art. In summary, each disc will comprise at least one layer comprising an optically transparent material (transparent substrate), coated with a reflective layer. Suitable optically transparent materials will be apparent to the skilled person and include plastics, glass, mica, silicon, and the like. Plastics are preferred, particularly polycarbonate, as these are conventional materials for use with CD-ROM and DVD readers. The transparent layer is usually approximately 0.1 millimetres thick and the reflective layer is usually much thinner, for example between 10 and 100 nanometres thick. The reflective layer is usually a thin dielectric layer, but other reflective or semi-reflective materials, such as silver silicon, aluminium, tellurium, selenium, bismuth, copper, or any other suitable reflective material can also be applied. The transparent layer and reflective layer may also contain operational structures, such as a wobble groove for laser tracking and autofocusing and/or pit structures for speed control. In a preferred embodiment, the reflective material is of low reflectivity or is semi-reflective. This is desirable in those embodiments where measurement of reflectivity is carried out by focussing laser light on the underside of the optical disc, i.e. through the transparent layer. The analyte to be characterised is therefore on the laser distal side of the optical disc. In the context of a low or semi-reflective layer, it is preferable that the material chosen reflects less than 50% incident light, more preferably less than 30% incident light, and most preferably less than 10% incident light.

Optically readable structures on optical discs are commonly referred to as “pits” and “lands”. These may have the shape of actual physical pit and land structures but “pits” and “lands” may in a more general sense be used to denote discrete areas on the disc with distinctive reflectance differences (DVD Players and Drives, K. F. Ibrahim, Newnes, Oxford, 2003).

Although in one embodiment the reflective layer is the top surface of the substrate, in an alternative, preferred, embodiment a protective layer is provided above the reflective layer. The protective layer may be used in the encoding process, whereby at the appropriate sites of reaction, the protective layer is eroded or ablated to expose the reflective layer for subsequent etching (disruption) e.g. wet etching. For example, the protective layer may be a self-assembled monolayer of single stranded DNA, which can be degraded by an exonuclease localised at sites of interaction. References to “disrupting” the reflective layer are also intended to include altering the reflective layer.

The provision of a monolayer allows different chemistries to be adopted to prepare the monolayer for subsequent disruption. The subsequent etching of the reflective layer can then be carried out using conventional techniques to provide well-defined disruptions to the reflective layer. For example, wet-etching, using chemicals to corrode the reflective layer can be used.

When the substrate is a disc, the disc according to the current invention may include at least one flow channel that allows liquids to be transported within the disc, for example when under centrifugal force, applied as the disc spins. Micro-fluidic possessing of biological samples on compact discs are known in the art, for example as described in Gustafson et al, supra. The flow channel allows liquid samples, for example a sample containing the polymer, to be distributed within the disc. It will be apparent to the skilled person that the flow channel should be configured so that the sample contacts the correct area of the disc. The flow channel can be positioned anywhere on the disc.

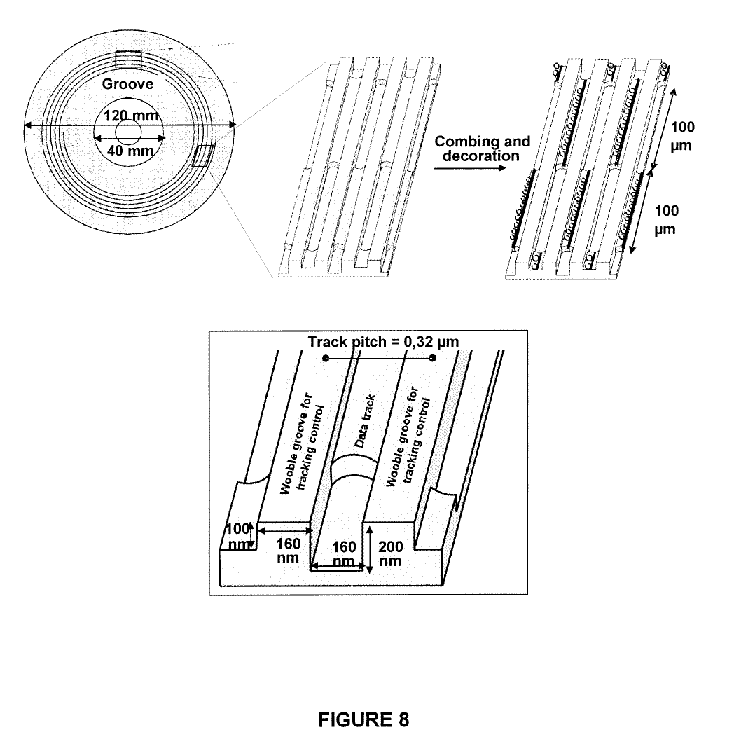

In the preferred embodiment, the substrate is a disc, and can be manufactured using conventional techniques employed in the manufacture of DVD and HD-DVD discs. The discs can comprise a tracking groove, which is used by a laser beam in the final read-out stage. A data track is also provided on which the reaction will proceed. Unlike conventional optical discs, the disc of the invention can further comprise additional indentations in the tracking groove (usually approximately 100 μm in length and 200 nm in depth) which are to be used in aligning (combing) of a polynucleotide (second polynucleotide) within the data track. This is shown in FIG. 8. The discs are prepared using conventional stamping technology, where a master copy is prepared by injection moulding and this is then used as the stamp to prepare the copies. The top layer of the substrate is usually the reflective layer. This is usually a metallic layer, which is laid down on the substrate surface with conventional sputtering techniques.

In a preferred embodiment, the optical disc comprises a transparent solid substrate (e.g. polycarbonate) and a reflective material (reflective layer) disposed on the top surface of the transparent substrate, and further comprises a layer of a compound coating the top surface of the reflective material, i.e. the reflective material is sandwiched between the compound layer and the transparent layer. This differs from conventional recordable CDs or DVDs where a compound is sandwiched between the reflective layer and the optically transparent material. This new configuration has benefits when used in the methods of the invention, as described below.

The compound provides a protective layer which can be exposed, for example, to ablation, to form predetermined pits on the optical disc. The pits may have the reflective layer exposed. The remaining compound layer will form “lands” on the optical disc.

Optical discs having this configuration are advantageous for carrying out preferred methods of the invention. In certain preferred methods it is intended to discriminate between pits in which a reaction has occurred and pits where no reaction has occurred. One way of achieving this is to modify the pits where a reaction has occurred, or modify the pits where a reaction has not occurred.

In one embodiment, modification is achieved by disrupting or removing the reflective layer. Those pits where a reaction has occurred (or alternatively where a reaction has not occurred) are treated so as to block access to the pits.

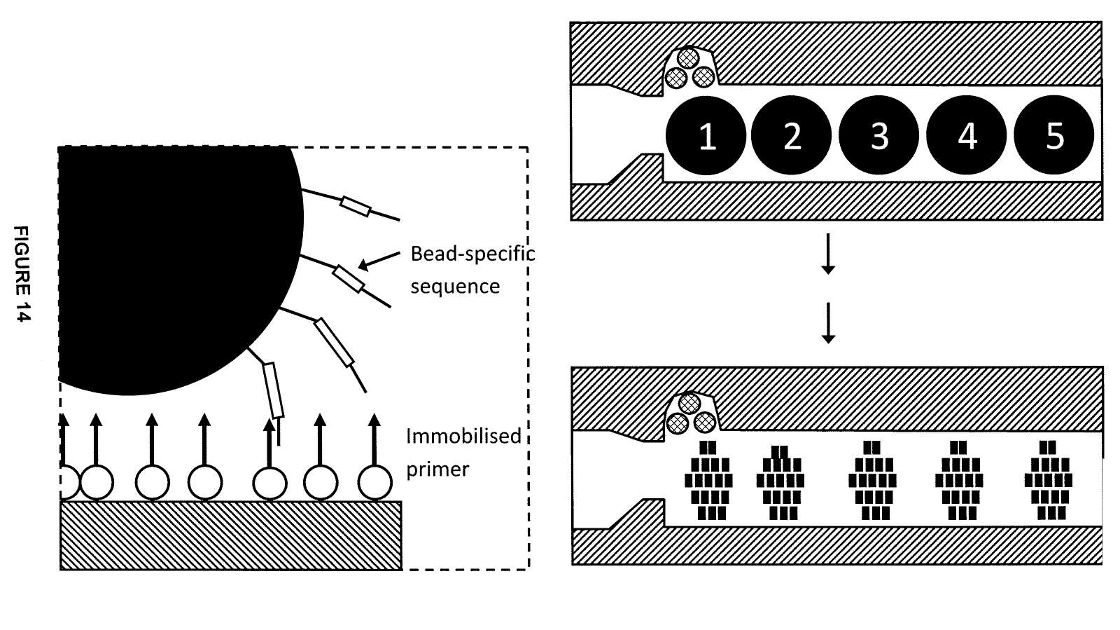

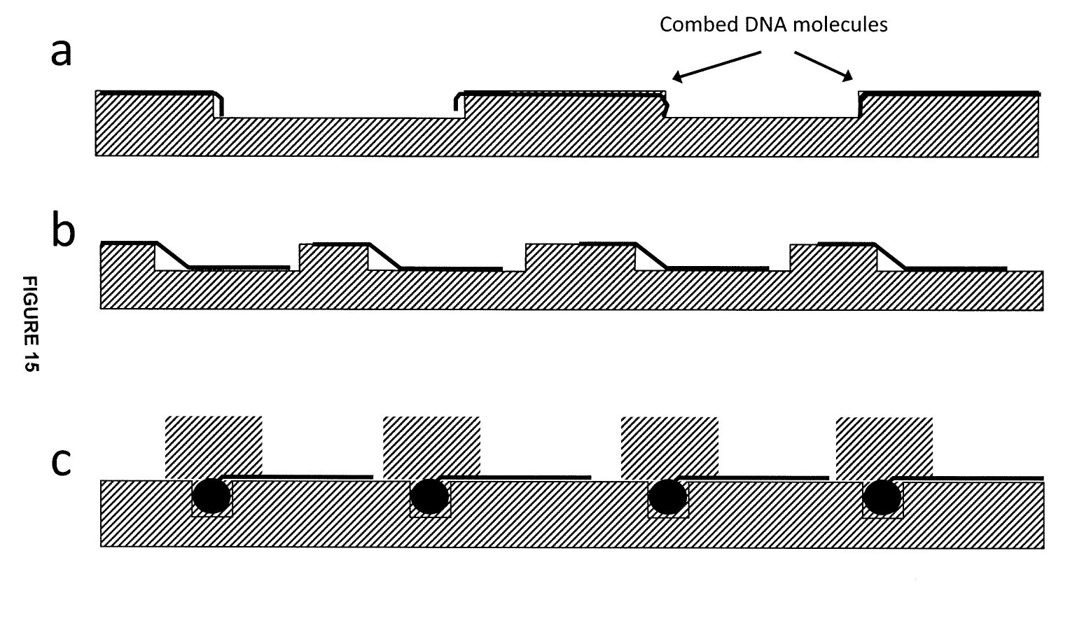

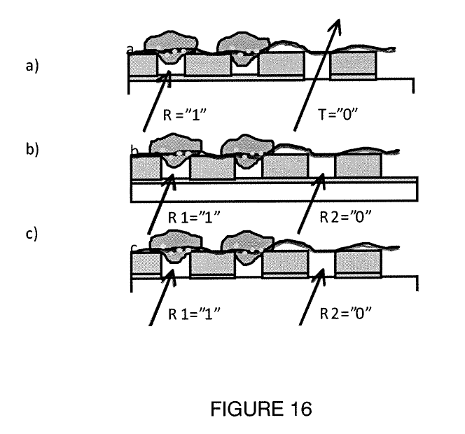

Etching (e.g. wet etching) can then occur in the non-blocked pits to disrupt or remove the reflective material. The organic compound layer in this embodiment is etch-resistant, protecting the remaining surface of the optical disc from the etching process. This is shown in FIG. 16a and b and also FIG. 17 and FIG. 18.

In a preferred embodiment the compound is an organic dye, e.g. Ciba® IRGAPHOR® ultragreen MX. Alternative etch-resistant organic compounds include dye polymers. These can be spin-coated onto the optical disc using conventional techniques. Preferably, the compound is susceptible to treatment by a laser to create the pits. Compounds that can be ablated in this way will be apparent to the skilled person. In particular, the compound layer will typically be formed from materials that can absorb visible UV light and be removed by such light. The visible or UV light is usually provided using a laser with an output below 100 mW, preferably below 50 mW, more preferably below 20 mW. Suitable materials are known from conventional recordable CD discs. The material for the compound layer will usually be resistant to the techniques used to etch the reflective layer. For example, the compound layer will be wet-etch or acid-etch resistant.

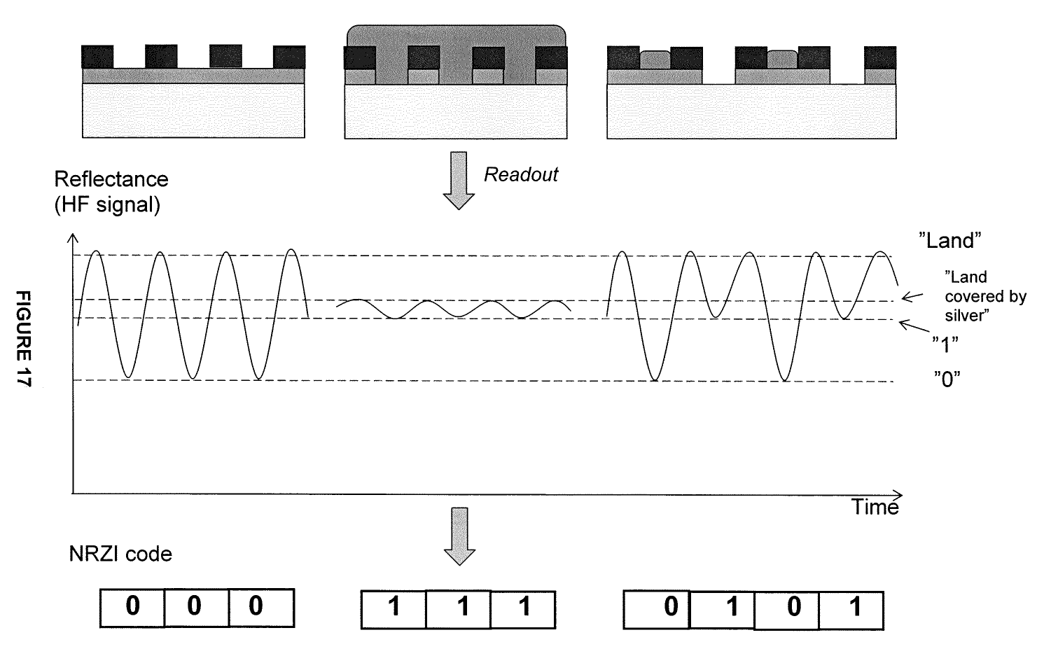

In one embodiment, the pits are formed in the compound layer and the corresponding reflective layer to expose the transparent substrate in the pits (FIG. 16c and FIG. 19). The benefit of this is that light is transmitted through the pits which are not blocked, but is reflected when the pits are blocked. This configuration can be achieved by ablating the pits in the compound layer and then carrying out wet-etching to remove the reflective material exposed in all of the pits prior to carrying out the analysis.

In a further alternative embodiment, the pits are formed in the compound layer, exposing the reflective material which is left unmodified. No wet-etching is then required. In this embodiment the compound layer does not need to be etch-resistant.

The term “ablation” refers to the treatment of the compound layer to laser light to burn defined pits into the surface of the optical disc. The ablation can be carried out with any suitable apparatus. Preferably, the ablation is carried out with a semi conductor laser diode. the optical laser power will usually be below 50 mW, more preferably below 20 mW. The ablation time will vary depending on the material used for the compound layer. Typically the ablation time is below 1 μs per pit. During ablation, laser tracking can be performed by means of operational structures on the disc. Tracking and focussing can be performed by utilising light reflected from the reflective layer. The depth of the pits formed by the ablation process will depend on the thickness of the compound layer, typically a depth of 5 nm to 100 nm will be achieved.

The present invention provides a disc with 3 or 4 distinct “height levels” that are exposed to the open surface. There is an off-groove level with reflective material and dye; an on-groove level with reflective material; a dye on-groove level with reflective material (where the dye is ablated); and an on-groove level without additional materials (the dye is ablated and the reflective material is disrupted).

The fabricated optical discs are to be used to identify characteristics of a molecule, e.g. polymer molecule. When the optical discs comprise pits, the molecule is to be localised within pits, e.g. by immobilisation.

In a preferred embodiment, the molecule is a polymer molecule, e.g. a polynucleotide, and is bound to an affinity partner to identify one or more of its characteristics. The binding of the affinity partner can be used to also localise other reagents within the pits to effectively block the pits from exposure to other materials or to alter the reflective properties of the pits for subsequent detection.

As stated above, the present invention is particularly suitable for determining sequence information of polymers. The invention allows individual monomers of the polymer to be encoded on the optical substrate. In contrast to methods that rely on sequencing by hybridisation a much smaller part of the polymer sequence can be “addressed”, i.e. encoded onto the substrate. However, as the present invention also provides positional information, it is possible to say where the part of the sequence belongs on the target sequence based upon where the address which revealed the sequence piece belongs in a predefined address pattern. The simplest address pattern is a pattern where the addresses representing base-1, base-2, and so forth of the target sequence are aligned linearly along the lasertrack. Using the pits, it is possible to have one monomer for each pit. As the bases in the target sequence are arranged in a specific pattern on the disc, this makes it possible to determine where in the target sequence the sequence piece identified by the pit (from ½ a base to 5 bases) belong only based upon the position the address (or pit) has in the pattern. Each target sequence can be identified with a relatively low number of addresses (e.g. 48 addresses in order to sequence a 24 mer based upon a 2 bit per base approach).

One way of achieving this sequencing strategy is to amplify the target molecules and distribute them to different locations (prefabricated array addresses) on the optical substrate surface, where each location has been prefabricated so it will interrogate with a specific base position(-s) in the target molecule.

In a preferred embodiment the surface pattern of the prefabricated array are made in a format that allows data storage technologies to be used as a read-out modality. This will normally require that the pattern is made binary and aligned with operative information.

In a particularly preferred embodiment, the optical disc of the invention comprises a reflective layer with a series of pits and lands, wherein one or more of the pits comprise a polymer molecule with an affinity partner bound thereto, the pits with the affinity partner having a material positioned at or within each pit, and where the pits which do not have the affinity partner do not have a reflective layer.

In a further particularly preferred embodiment, the optical disc comprises a series of pits and lands, where one or more pits comprise a polymer molecule with an affinity partner bound thereto, where the pits with the affinity partner have a material positioned at or within each pit, characterised in that the optical disc does not comprise a reflective layer at the base of the pits.

In a still further preferred embodiment, an optical disc of the invention comprises a reflective layer and a series of pits and lands, where one or more of the pits comprise a first polynucleotide with a second polynucleotide bound thereto, the pits with the first and second polynucleotides having a material positioned at or within the pits characterised in that the first polynucleotide comprises a series of sequence units, each unit comprising a plurality of nucleotide sequences representing a specific characteristic, such polynucleotides are disclosed in WO-A-04/094664 and WO-A-00/39333, the content of each of which is incorporated herein by reference.

The material used to block the pits may be a material which can provide effective blocking of the pits to other reagents. As the optical discs may be treated to wet-etching to disrupt the reflective layer, it is preferred that the material is resistant to the selected wet-etching process. In other embodiments, no wet-etching is to take place and so the material does not have to be wet etch-resistant. However, the material may be selected for its ability to alter the reflective properties of the pits, to aid in the discrimination between the pits.

Metallic materials are particularly useful for this purpose. A metallic material may be deposited selectively at the pits, for example by enhancement techniques. Silver enhancement is particularly preferred and commercially available kits are available for this. Selective silver enhancement may be carried out as detailed below.

Alternative materials may also be used. For example, DNA may be localised in the pits at sites of reaction, to act as a barrier during wet-etching. Polymers may also be used, or inorganic particles may be located within the pits, to provide a protective layer. Aromatic thiols are etch-resistant and so can be added to the particles to provide a more effective barrier. Latex particles can also be localised within the pits, for example by use of affinity tags present on the latex particles and the polymer (or its affinity partner) present in the pits. The latex particle will form a film to resist wet-etching.

If wet-etching is not to be used to modify the pits, the material added selectively to the pits may be chosen for its ability to modify reflectivity. For example, functionalised-metallic particles may be localised within pits. These are targeted selectively to those pits which have a polymer/affinity partner complex. The reflectivity can then be measured, and the different pits (those with and without the complex) can be distinguished.

In a further alternative embodiment, the material modifies the reflective layer to disrupt or remove it, thereby altering the reflective properties of the pits. Suitable materials include gold particles which react with a silver layer (reflective layer) by galvanic corrosion. The gold particles can be selectively targeted to the pits by functionalised groups.

The present invention can be used to study molecules, e.g. biological molecules. The target molecule will usually interact with one or more molecules on the substrate to identify characteristics of the target molecule. The method of the invention is carried out so that an interaction between the target molecule and a molecule on the substrate can be monitored due to subsequent modification of the substrate, e.g. by disrupting the reflective layer at the sites of interaction. This can be achieved by carrying out a subsequent reaction to remove unreacted molecules and targeting and modifying the sites of interaction. The invention is now described in further detail with reference to a polymer as the target molecule. The skilled person will however appreciate the broader aspects of the invention.

The present invention is carried out by localising a polymer onto the substrate to allow the polymer to be interrogated, for example at various regions which will translate to different regions of the substrate.

Localising molecules onto the substrate for interrogation can be carried out using any suitable technique. WO-A-01/15154 describes various ways for physically patterning biological molecules onto an optical disc. For example paramagnetic beads are patterned on the optical substrate using magnets. The paramagnetic beads can be used to localise analytes (molecules) at specific positions on the optical disc. Alternative methods for localising the molecules on the optical disc are found in U.S. Pat. No. 7,083,920.

In those embodiments utilising optical discs with pits and lands, it is necessary to localise either the target polymer or its affinity partner within the pits. Methods for depositing or attaching biomolecules and other molecules and reagents in an addressable and ordered way onto solid surface sites, with an approximate size corresponding to the size of optically readable structures on optical discs (e.g. CD, DVD and HD DVD), are well known to the skilled person [Microsystems Technology in Chemistry and Life Sciences. A. Manz, H. Becker (eds.), Springer, Berlin 1999; Immobilisation of DNA on Chips, Vol I & II, C. Wittman (ed.), Springer, Berlin, 2005; Immungold-Silver Staining, M. A. Hayat (ed.), CRC, 1995]. Such addressing methods comprise e.g. microcontact printing, scanning probe lithography, electron beam lithography, UV or optical lithography, nanografting, and dip-pen nanolithography. The molecules or reagents may be covalently coupled to the solid surface, or the binding may be of a physical nature such as van de Waals binding, hydrogen bonding, ionic binding, dipolar binding, hydrophobic interaction, or other kind of physical absorption. The binding may also be nucleic acid hybridisation or biotin/streptavidin coupling. The binding may involve siloxane bonds, ester bonds, amide bonds, or thiol bonds. The binding reaction may involve phosphoramidite reactants. The binding may also involve self assembled monolayers. Methods of performing chemical reactions on such sites are well established. Such reaction include e.g. hybridisation of DNA and/or RNA strands on oligonucleotide arrays, labelling of molecules with fluorescent reagents, biotin/streptavidin coupling, antibody/antigen binding, gold labelling with streptavidin-gold or Protein A-gold, gold and silver enhancement, immunogold-silver staining, and different enzymatic reactions.

Localising the polymer or affinity partner in the pits can make use of the functionalised groups provided in the pits. For example it is possible to make use of the chemical differences between the lands (the organic compound layer) and the pit-exposed reflective layer or transparent substrate, to selectively provide functional groups within the pits.

In one embodiment, the polymer is aligned on the substrate surface in a substantially linear conformation, which allows the polymer to be interrogated at different positions along its sequence, allowing disruption to occur on the substrate surface and regions corresponding to the interrogated portions of the polymer. However, in alternative embodiments, the polymer may be localised at the substrate surface through a specific interaction with a molecule attached to the substrate surface, with this interaction being encoded onto the substrate surface to thereby indicate and characterise the specific interaction. In this context, the polymer does not have to be localised in a linear conformation.

As used herein, the term “Polymer” refers to any molecule which comprises a plurality of monomer units. Preferably, the polymer is a biological polymer, most preferably a polynucleotide or a polypeptide. These terms are well-known to one skilled in the art.

As used herein, the term “substantially linear” refers to the polymer following a direct route between the termini of the polymer when localised on the substrate.

The polymer may be localised onto the substrate using any conventional technique. The polymer may be located directly onto the substrate surface for subsequent interrogation, or may be localised indirectly via one or more intermediary molecules. The intermediary molecule(s) may be used as part of the interrogation step, i.e. the intermediary molecule(s) may act to both localise the polymer and interrogate the polymer. The sites of localised interaction between the polymer and the intermediary molecule(s) can then be identified and characterised by disrupting the reflective layer at those sites. Alternatively, the intermediary molecule(s) may act to bind or tether the polymer to the substrate, but does not interrogate the polymer.

The term “interrogate” is used herein to define a specific interaction between the polymer and another molecule. The interaction can be a binding event, for example a hybridisation event between a polynucleotide (as the polymer) and a complementary polynucleotide (as the other molecule). The interrogating event is specific for the polymer, or a portion of the polymer, i.e. there is an interaction that is in some way dependent on the sequence of the polymer. Accordingly, the interaction can be characterised, revealing sequence information of the polymer.

In one embodiment, the invention is carried out using a polynucleotide as the polymer.

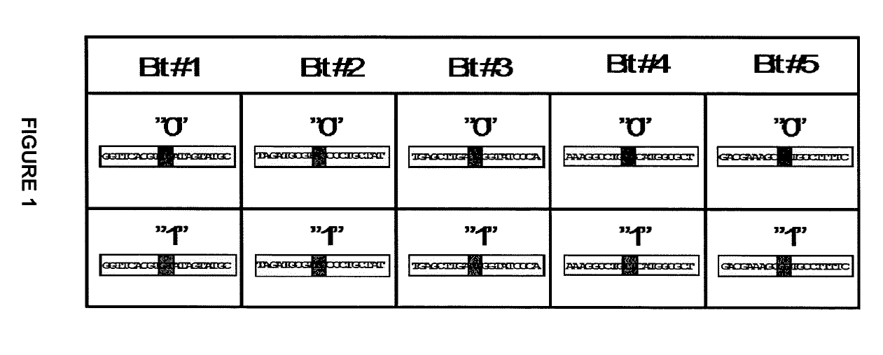

The polynucleotide may be a “design polymer” and comprises a sequence of defined polynucleotide sequence units, said to be of binary code, ie. each sequence unit represents either a “1” or “0”, differentiated by a difference in nucleotide sequence. This is represented in FIG. 1, which shows that at each sequence unit position “bit position”, the sequence units at that position for both “0” and “1” comprise the same sequence other than the central two nucleotides, which characterise either “0” or “1”. The design polymer has been formed with knowledge of the common sequences at each bit position, but without knowledge of whether the sequence of each bit is a 0 or a 1 sequence. The 0 or 1 sequence bit information is used to characterise information from a different molecule, ie. the order of 0 and 1 bits characterises the sequence of an original target polynucleotide. The present invention can be used to characterise whether a “0” bit or a “1” bit is present at each bit position.

The target polynucleotide may be designed to include internal controls, which will be encoded onto the optical substrate. The incorporation of internal controls into polynucleotides is described in WO-A-2006/092588, the content of which is hereby incorporated by reference. The “control sequences” are detected by oligonucleotides present on the optical substrate and the interaction between the control sequences and oligonucleotides is encoded onto the substrate. The control sequences may be used to identify the start of the sequence information, which will be of use in the eventual read-out step to allow the read-out technology to initiate the scan. The control sequences may also be used in quality control, to ensure that correct sequencing has taken place.

The determination of different characteristics of a target polymer may be carried out using the optical discs prepared with the preformed pits and lands. The target is localised on an optical substrate having pits and lands, and the following steps carried out:

(i) carrying out a series of reactions to interrogate different defined characteristics of the target molecule, wherein each of said reactions occurs in a distinct pit;

(ii) treating the optical substrate to modify either those pits where a reaction has occurred, or alternatively, those pits where a reaction has not occurred, to alter the reflective characteristics of the pits; and

(iii) measuring reflectivity within the pits, to thereby determine different characteristics of the target.

Step (i) can be carried out by reacting the target molecule with a second molecule which binds to the target molecule if the target molecule has a particular characteristic. A metallic particle can be localised at or within the pit, either by being bound to the second molecule prior to or after the reaction. The metallic particle acts to direct metallic enhancement, thereby selectively depositing a metallic layer at or within those pits which contain the reacting molecules. The metallic particle can be bound to the second molecule, so that it is localised if the second molecule binds to the target. Alternatively, if the second molecule is immobilised within the pits, and the target is introduced onto the disc for reaction with the second molecule, the target may be labelled with the metallic particles.

In a preferred embodiment the metallic particle is added after reaction between the target and the second molecule. For example, if the target is a polynucleotide and the second molecule is a primer sequence, a polymerase reaction can be carried out to incorporate labelled nucleotides onto the nascent strand. This only occurs if a binding reaction has taken place. The result is to modify those pits where a reaction has taken place.

Further modification of the optical disc can be carried out, to remove the reflective layer from those pits where a reaction has not taken place. This can be achieved by wet-etching, as described above. Alternatively, the reflective layer in all of the pits can be removed prior to carrying out the reactions. After the reaction, the optical disc is “read” to provide a signal read-out of those pits where a reaction has occurred, and those where no reaction has taken place.

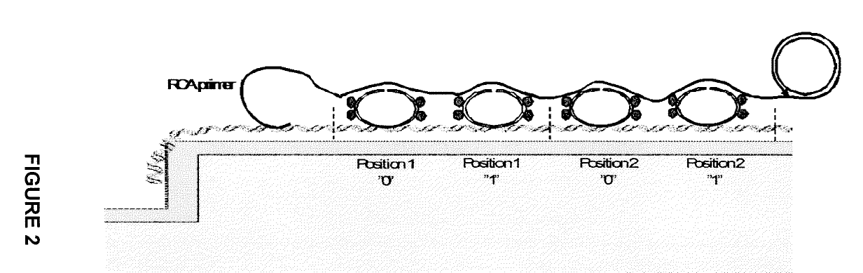

In one embodiment, interrogation of a polynucleotide is carried out by first immobilising a plurality of oligonucleotide probes onto the substrate. The oligonucleotides are each specific for a specific sequence of the polynucleotide and so can bind specifically, ie. without mismatch, to specific sequences of the polynucleotide. In the context of interrogating a polynucleotide design polymer, the oligonucleotides are arranged on the substrate with the knowledge of the ‘bit’ sequences common to each 0 or 1 bit. Oligonucleotides for both 0 and 1 bits are present on the substrate at different portions, as shown in FIG. 2. Oligonucleotides complementary to the respective sequence on the polynucleotide will hybridise. Accordingly, only those oligonucleotides which are fully complementary to the polynucleotide will hybridise in their entirety.

The oligonucleotides may be positioned onto the optical substrate using any conventional technique. In one preferred embodiment, the oligonucleotides are positioned by having a region that hybridises to a polynucleotide (second polynucleotide) that is adsorbed onto the surface of the optical substrate and which is in a substantially linear conformation. This is shown in FIG. 2. The second polynucleotide is of a defined sequence, intended to allow the oligonucleotides to hybridise at specific known regions on the substrate and at the same time not allowing cross-hybridisation with the target polynucleotide to occur.

The second polynucleotide can be positioned on the substrate surface using techniques known to those skilled in the art. In particular, the second polynucleotide is positioned on the substrate surface using a modification of the molecular combing technique disclosed in Guan and Lee, PNAS, 2005; 102: 18321-18325, the content of which is hereby incorporated by reference. In this technique, large polynucleotide molecules can be arranged in a highly ordered conformation, to form stretched nanostrand arrays. To achieve combing, a DNA solution is flowed onto a substrate surface. In the present invention, the substrate surface comprises discrete single (second) polynucleotides localised at specific sites. This is achieved using much less concentrated amounts of DNA compared to that in Guan and Lee. Alternative methods for attaching the second polynucleotides will be apparent to the skilled person.

To carry out the combing procedure it may be desirable to anchor the DNA (polymer) at a terminal region to the support surface. Preferably, after combing, the DNA (polymer) is anchored at each terminus. Anchoring can be carried out using conventional chemistries to provide a covalent link between the DNA and the support surface. In one embodiment, the anchoring of a terminal region occurs in a well provided at a specific position on the substrate. The well may be provided with suitable linker molecules to effect anchoring. In this way, the position of the DNA molecules on the substrate can be pre-determined.

The second polynucleotide will be any suitable size, typically from 50 KB to 300 KB in size, most preferably approximately 200 KB in size.

In the context of studying design polymer polynucleotides, the second polynucleotide is designed so that it permits hybridisation of oligonucleotides for each “bit” sequence (0 and 1) at each bit position on the target polynucleotide. The oligonucleotides that hybridise to the second polynucleotide will therefore be ordered correctly on the substrate, so that the interactions between an oligonucleotide and the target polynucleotide can be characterised correctly to reveal the sequence of the target polynucleotide and the position of this sequence relative to other identified sequences.

Once the substrate has been prepared, the target polynucleotide is brought into contact with it, allowing reaction between the target and the oligonucleotide to proceed. The target polynucleotide may be brought into contact with the substrate/oligonucleotides in any suitable way.

In one embodiment, the target polynucleotide is synthesised on the substrate surface using rolling circle amplification. This is described in WO-A-2008/032058, the content of which is incorporated herein by reference. Rolling circle amplification involves the amplification of a circular DNA “the design polymer” by polymerase extension on a complementary primer (the interior oligonucleotide). This process generates concatemerised copies of the circular DNA. This is shown in FIG. 2. The resulting “super design polymer” is intended to provide greater separation between the “bit” sequences, allowing the bit sequences to be interrogated by spaced apart oligonucleotides on the substrate surface. For example, the first bit sequence in copy 1 of the design polymer is interrogated by first oligonucleotides (both 0 and 1). The second bit sequence is interrogated in copy 2 of the design polymer, and so on. Accordingly, it is possible for the oligonucleotides to be well separated, allowing greater discrimination in the subsequent encoding steps.

The next step in the process is to modify the substrate so that it encodes the information on the binding events between the polynucleotide (target polynucleotide) and the oligonucleotides. This is most readily achieved by modifying the reflective layer at the sites of each binding interaction, so that the reflective layer is disrupted at the sites of interaction, but unmodified at those sites corresponding to unbound oligonucleotide.

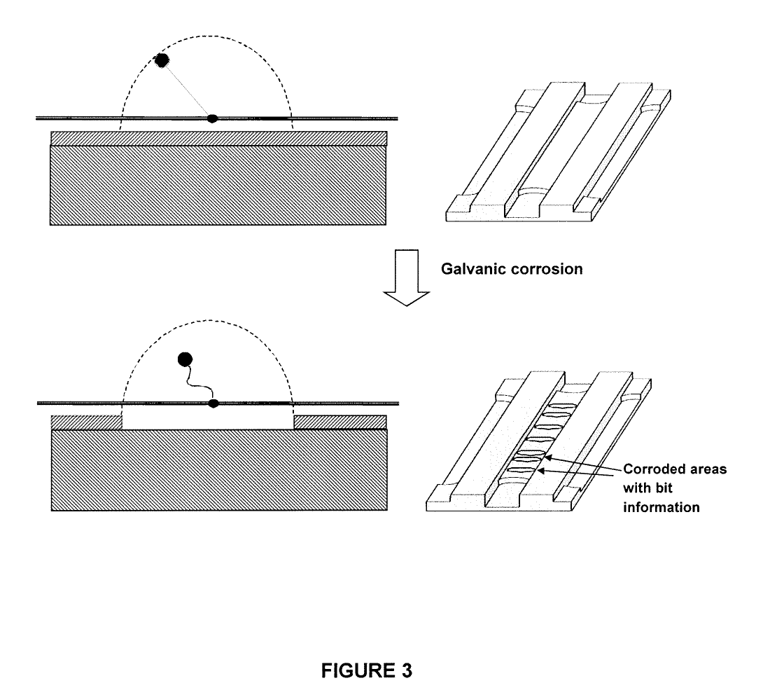

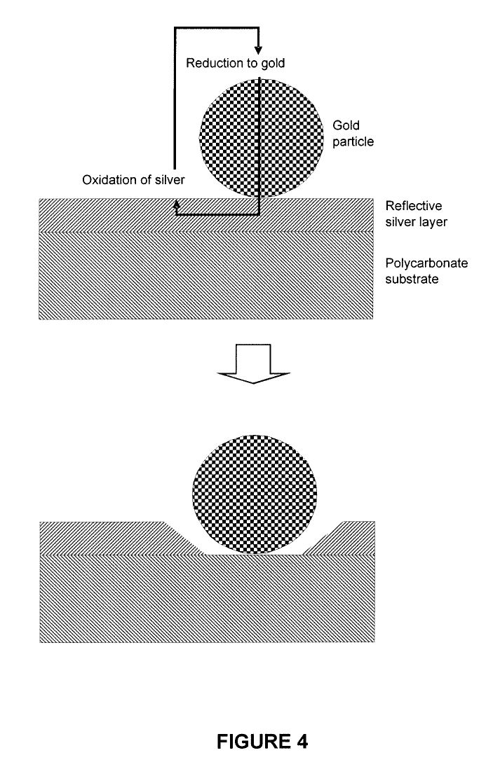

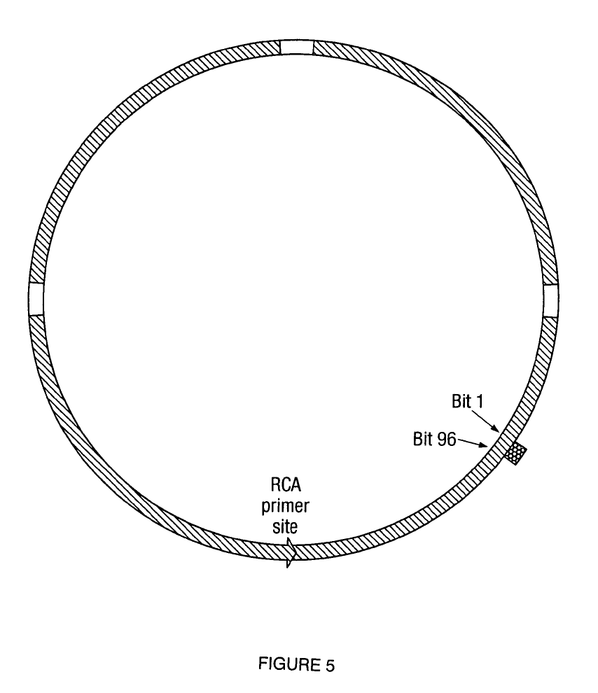

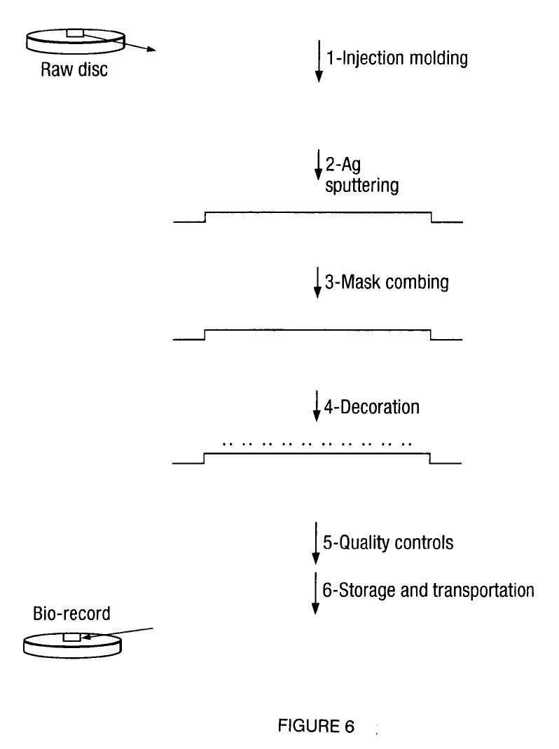

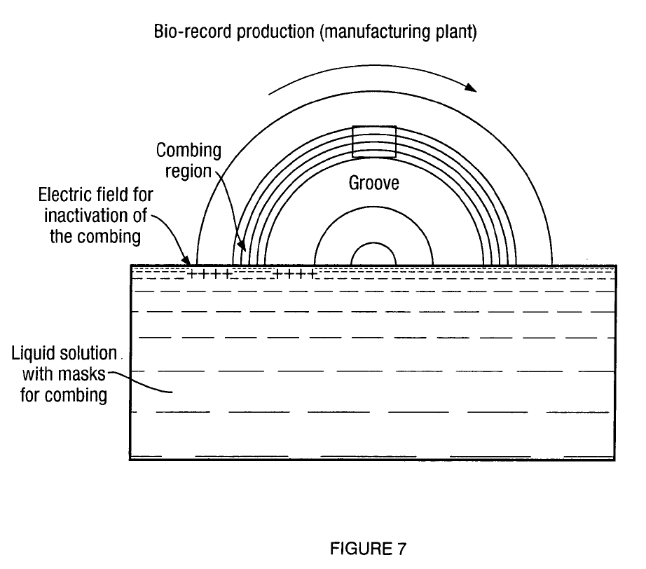

This may be achieved in various ways. In the preferred embodiment, when oligonucleotides are used to interrogate the target polynucleotide, those oligonucleotides that bind to the polynucleotide are labelled, and the label interacts with the reflective layer to disrupt the layer, eg. by degradation. This is shown in FIGS. 3 and 4; wherein the label is a gold particle that interacts with a silver reflective layer to corrode the layer at a defined site. The label may be attached directly on the oligonucleotide or may be tethered to the oligonucleotide via a linker molecule, a shown in FIG. 3. The label can be introduced onto the interacting oligonucleotides after the hybridisation with the target polynucleotide. The oligonucleotides can therefore comprise an affinity molecule capable of capturing a label in a subsequent step.

In one embodiment, the oligonucleotides comprise termini that are free to interact (interrogate) with the polynucleotide, wherein, on hybridisation with the polynucleotide, the termini hybridise at adjacent positions. This allows a ligase to be used to ligate the termini to create a circular oligonucleotide. Those oligonucleotides which are not completely complementary to the polynucleotide are unable to be ligated by the ligase and the termini are therefore exposed for subsequent nuclease attack. The purpose of the subsequent nuclease reaction is to remove from the substrate those oligonucleotides that are not fully complementary to the polynucleotide. In the embodiment described above, this process allows the user to discriminate between the “0” and the “1” bits at each bit position.

Nuclease degradation can be carried out using conventional methodologies. Suitable exonucleases, such as ExoI and ExoII, can be used to degrade non-ligated oligonucleotides. The reaction methodologies may be as described in Szemes et al; Nucleic Acids Res., 2005; 33(8):70, the content of which is hereby incorporated by reference.

Prior to reaction with the polynucleotide, the oligonucleotides can be provided with an affinity tag to allow subsequent attachment of a label for degrading the reflective layer. For example, the oligonucleotides can be provided with one or more biotin molecules. The biotin can be reacted later, in the labelling step, with its affinity partner, avidin or streptavidin, which is linked to the label for degrading the reflective layer. Removal of those oligonucleotides that do not react with the polynucleotide provides a convenient method for allowing attachment of the degrading label only at the specific regions of interaction. The subsequent attachment of the degrading label allows degradation of the reflective layer to take place, thereby modifying the optical substrate to encode useful information regarding the target polynucleotide.

One method for degrading the reflective layer is to make use of galvanic corrosion, whereby one metal (the label) corrodes a second metal (the reflective layer) when brought into contact. The degradation is achieved using suitable electrochemical conditions. When the two metals are in contact in the presence of an electrolyte a galvanic reaction is created due to the different electrode potentials of the metals. The electrolyte provides a means for ion migration, whereby metallic ions can move from the anode to the cathode, resulting in anodic metal corrosion. In the present invention, a gold nanoparticle may be used as the label on the oligonucleotide, and silver may be used as the reflective layer. On contact, in a suitable electrolyte, corrosion of the silver layer will occur, corresponding to the sites of those oligonucleotides reacting with the target polynucleotide. This is shown in FIG. 4. The gold nanoparticle will typically be of a size approximately 5 nm in diameter, and will be attached to the oligonucleotide via a linker and a biotin/streptavidin bond. The linker will be of a suitable size to allow the gold to be brought into contact with the reflective layer within a defined area.

The reactions to be carried out, may take place in grooves on the disk. Positioning the polymer or other reagents in the grooves prior to the reaction may be carried out using any conventional means. As explained above, in the context of DNA, the DNA can be aligned using the technique of molecular combing.

In an alternative embodiment, functionalised nanobeads may be placed on the substrate in a defined arrangement, providing convenient binding sites for the polymers. For example, Yin et al, J. Am. Chem. Soc. 2001; 123 (3b):8717-8729 (the content of which is hereby incorporated by reference) discloses a technique by which colloidal particles can be assembled into well-defined aggregates. This is achieved using a patterned photoresist into which the nanoparticles are confined by being flowed over the photoresist in a liquid flow. Many groups have now used this system to create physical templates based on pre-fabricated relief patterns on the surface of a substrate, to dictate and guide the growth of colloidal particles. Suitable techniques are disclosed in:

Y. N. Xia et al., Adv. Funct. Mater., 13 (2003), 907;

A. van Blaaderen et al., Farad. Disc., 123 (2003), 107;

A. van Blaaderen, Mat. Res. Soc. Bull., 29 (2004), 85;

A. van Blaaderen et al., Nature, 385 (1997), 321;

J. P. Hoogenboom et al., Nano Lett., 4 (2004), 205; and

K. H. Lin et al., Phys. Rev. Lett., 85 (2000), 1770

(the content of each of which is incorporated herein by reference).

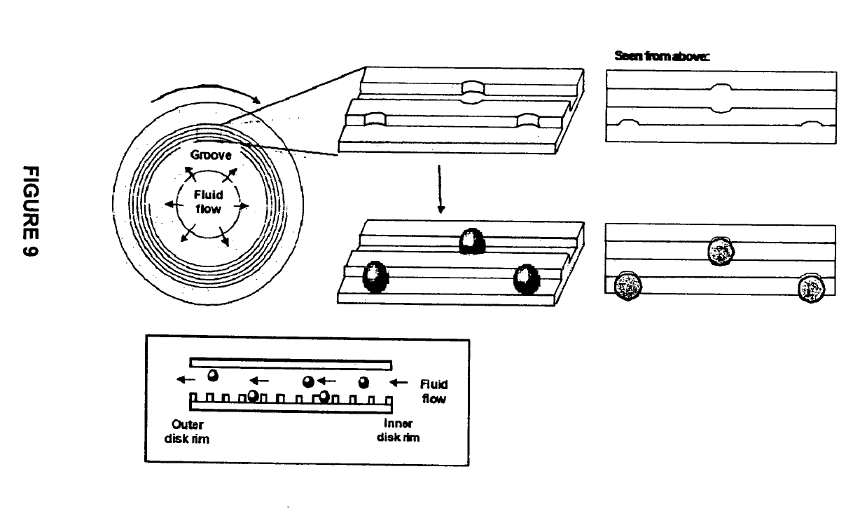

The present invention can make use of these techniques to provide functionalised beads in well-defined positions on the substrate surface, to act as a point of attachment for the polymer or other reagent. In one embodiment, shown in FIGS. 9 and 10, the grooves in the substrate are indented at defined positions to allow incorporation of one or more nanobeads. The nanobeads are flowed over the substrate under centrifugal force, to force the nanobeads to embed within the indentations.

Once the nanobeads are in position they can act to bind to and tether the polymer (or other reagent) via a functionalised linker. This will be of benefit in the combing technique, to align the polymer correctly on the substrate surface.

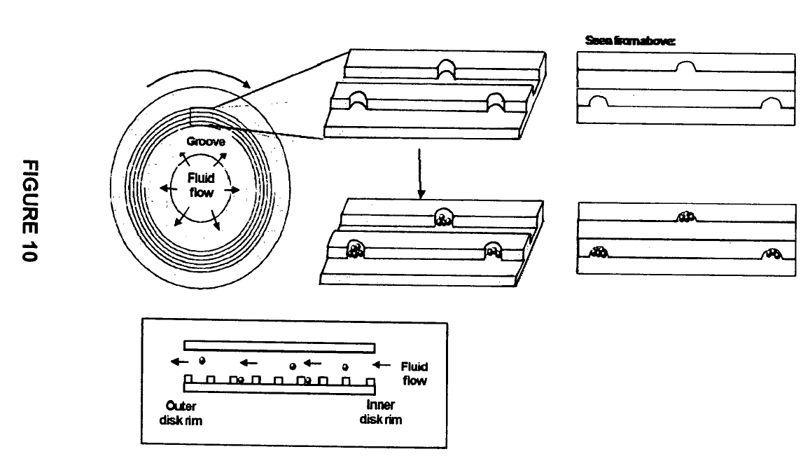

In addition to their use in aligning the polymer, the nanobeads may also be used to create localised regions containing multiple copies of an oligonucleotide, e.g. to create localised self-assembled monolayers of oligonucleotides. This is illustrated in FIG. 11. As shown in FIG. 11, the nanobeads can be used to align a DNA molecule (e.g. along a groove) in the substrate, which can then be interrogated to bind individual oligonucleotides at specific locations on the substrate. Copies of each oligonucleotide can be made, and these are localised using conventional chemistries, e.g. via affinity interaction. The localised oligonucleotides can then be used to interrogate the target, for example, as explained above. Each localised set of DNA can define a specific sequence on the target, or “bit” region, as described above.

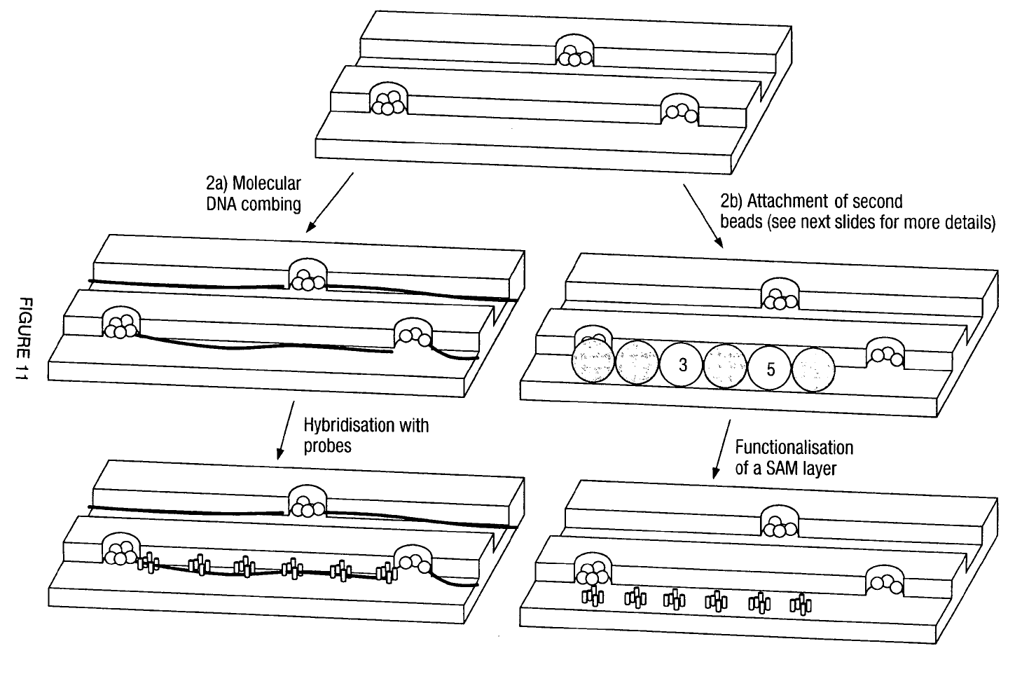

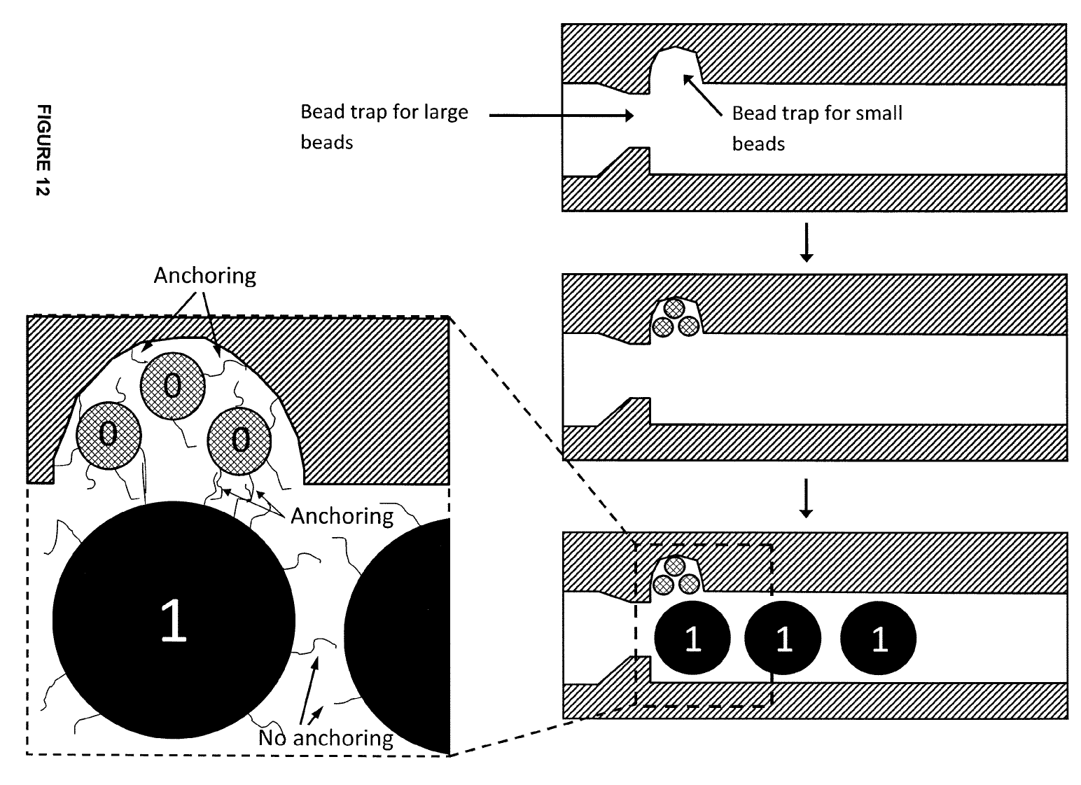

FIG. 11 shows also an alternative, whereby the copies of the oligonucleotides are arrayed on the substrate surface, by making use of additional functionalised beads. The embedded beads are used to anchor a first larger “positional” bead, as shown in FIG. 12. The positional bead is localised in the groove of a disk. Unbound beads are removed and then a secondary bead is introduced and anchored to the first positional bead (as shown in FIG. 13). The first and second beads have affinity molecules which allow the sequential ordering of the beads. Additional beads can be added in a similar way, with removal of non-bound beads (shown in FIG. 14). The beads are functionalised to allow the formation of self-assembled monolayers at regions corresponding to each bead. Accordingly, by controlling the order and type of beads, defined monolayers of olignucleotides can be produced (as shown in FIG. 14).

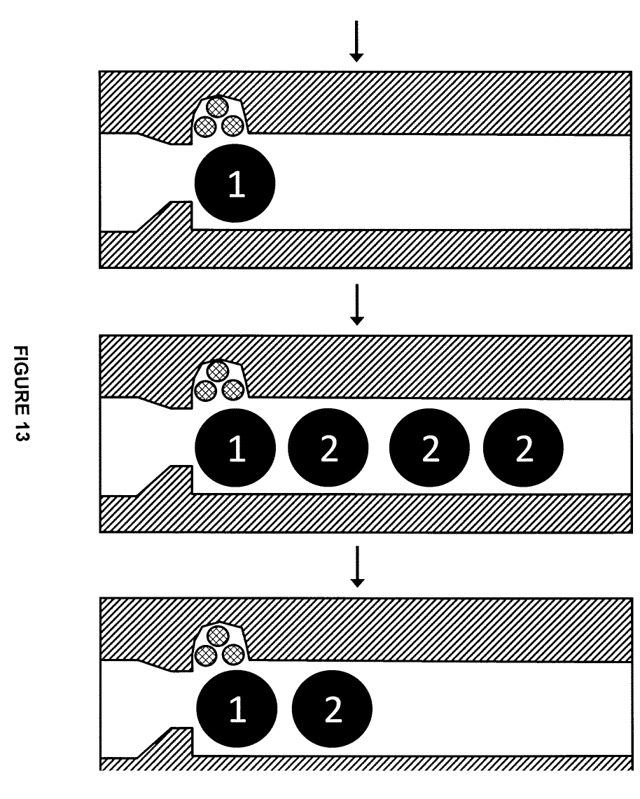

FIG. 15c illustrates the use of the nanobeads to anchor a DNA molecule with subsequent alignment of the DNA by combing. Alternative combing methods are shown in FIG. 15 (a) and (b), where the DNA is attached to other structures pre-fabricated onto the substrate.

The polymer (DNA) can be aligned using the structures, whereby the polymer is anchored to one side of a structure and, through the effect of a flow solution, is aligned across the surface of a structure.

In an alternative combing technique, individual grooves or regions of the disk can be placed in a sealed environment, and selectively unsealed to allow combing to occur. After combing, the groove or region can be resealed, to allow combing of other grooves/regions to take place.

Once the substrate has been encoded with the information, standard optical readers may be used to read the substrate. These are well known in the art. Custom-built readers, for example with multiple lasers or improved hardware for signal processing, may also be used.

As will be appreciated, the invention may be implemented using optical discs and corresponding reader hardware according to various standards including CD, DVD and HD-DVD. In use, the disc is read by causing laser light to be incident upon the metallic surface or other structures within the track. The laser light is selectively reflected from the metallic surface such that in areas where the surface has been removed the laser light is scattered rather than specularly reflected. A suitably positioned detector is arranged to monitor receipt of the selectively reflected light from the surface as the disc rotates and produces an electrical output signal accordingly. The signal is amplified and shaped by appropriate electronics. The shaping of the signal waveform is used to clean the signal for later processing. To improve the signal quality and reduce errors it may be necessary to modify the wave shaping electronics accordingly. Following shaping the signal is then demodulated and output to a digital to analogue converter for downstream processing. Optionally an error detection and correction process may be applied to the data. A number of different techniques may be used to achieve this, although these may differ from standard techniques used by disc readers due to the positioning of the polymers upon the disc surface. However, the polymers may be arranged in a predetermined manner so as to allow error detection and correction techniques to be used, for example in combination with check digits or parity bits. Since there are various standard encoding formats for optical discs (such as NRZ and NRZI) a simple software conversion between these and the design polymer encoding can be achieved for conformity with the hardware use. In order to interpret the data generated, the optical head of conventional HD DVD drives can be used without modification. However, it is desirable to disconnect the read channel of the drive and SUM signals brought from the drive via test points. These signals can be fed into a detector which can interpret the changes in reflectivities.

In a particularly preferred embodiment, the laser light is directed from underneath the optical disc, i.e. the laser passes through the transparent material first, then onto the reflective material. Reflectance is measured using a detector underneath the optical disc. The laser therefore never passes into the analyte chamber or pit, or in other words, the analyte is situated on the distal side of the optical disc with respect to the laser and the laser light detector. This has been found advantageous as the top surface of the disc or the medium above it may contain contaminants or material of varying refractive index that may interfere with the signal or the focussing of the laser beam. Further, there may in some cases be a microfluidic compartment situated on top of the optical disc. This microfludic compartment may contain physical structures of varying optical properties, causing disturbances or interferences to the laser beam.

The following Examples illustrate the invention.

### Example 1

### Optical Disc with Pits for Use when Reading Information Encoded in Biomolecules

An optical disc was manufactured for the purpose of reading out the information encoded in biomolecules. The raw disc, consisting of a polycarbonate substrate, reflector layer and dye coating, was manufactured employing standard manufacturing methods and equipment (optical disc production line) used for optical media, such as CD and DVD.

A 0.6-mm-thick HD DVD polycarbonate substrate was first made using the injection molding module of a standard HD DVD production line (E-Jet molding machine). The HD DVD substrate was made with a standard groove structure.

A 25-nm-thick ZnS—SiO₂ dielectric reflector was sputtered onto the polycarbonate substrate using standard sputtering methods used in the optical disc and semi-conductor industries.

An optically active dye polymer coating (Igaphour Ultragreen CD-R dye, Ciba) was spin-coated onto the dielectric film, resulting in a film 40-nm-thick in the grooves and 6-nm-thick on the land in-between the grooves.

The disc was burnt (ablated) using an ODU-1000 (Manual Type) Optical Disc Drive Unit (Pulstec Industrial, Co.). The disc was burnt with a pattern consisting of periodically repeated pits and lands, typically 3-6T long pits separated by 6-11T lands using the ODU-100 optical disc drive's 405 nm laser set to 12 mW. HD DVD minimum pit length is 2T, corresponding to 0.204 μm. The pits were created at the laser distal side of the reflector, through the polycarbonate and the reflector, resulting in the ablation of the dye at the positions exposed to laser irradiation, forming physical pits in the dye. The removal of the dye was complete, exposing the dielectric reflector at the bottom of the pits, without significant amounts of dye residues at the pit bottom of the pit.

### Example 2

### Silver Enhancement of Biomolecules on an Optical Disc with Pit Features

An optical disc consisting of a polycarbonate substrate, ZnS—SiO₂ reflector and Ultragreen dye coating with pits was used for binding biomolecules to the disc surface and, subsequently, exposed to silver enhancement treatment for the formation of silver at the positions of the biomolecules.

Biomolecule 1: Streptavidin with Fluorophore and 1-nm-Au-Particle

For demonstrating silver enhancement on the optical disc, streptavidin labeled with 1-nm-Au (SA-Au) was used as a test molecule. The SA-Au was also labeled with a fluorophore by the manufacturer (FluoroNanogold-Streptavidin-Alexa, Cat#7316, Invitrogen) for facilitating detection of the biomolecules by fluorescence microscopy.

A 5 μl droplet of SA-Au solution with a concentration of 7*10¹¹ molecules/ml was placed onto the dye coating of the disc, incubating the disc surface with the biomolecule. After incubating for 75 min, the disc was rinsed with MilliQ water and then dried. Observation by fluorescence microscopy revealed attachment of SA-Au molecules to the surface, as well as an even distribution of the SA-Au on the disc surface.

The disc area incubated with SA-Au, as well as a surrounding area not incubated with SA-Au, was exposed to a silver enhancement solution (Prod# L24929, Invitrogen). The silver enhancement solution was left on the disc for 20 min and then rinsed with MilliQ water and then the disc was dried. The silver enhancement process resulted in silver deposition in the areas incubated with SA-Au but not in the areas without SA-Au. The result demonstrates silver deposition specifically in the areas with gold labelled biomolecules.

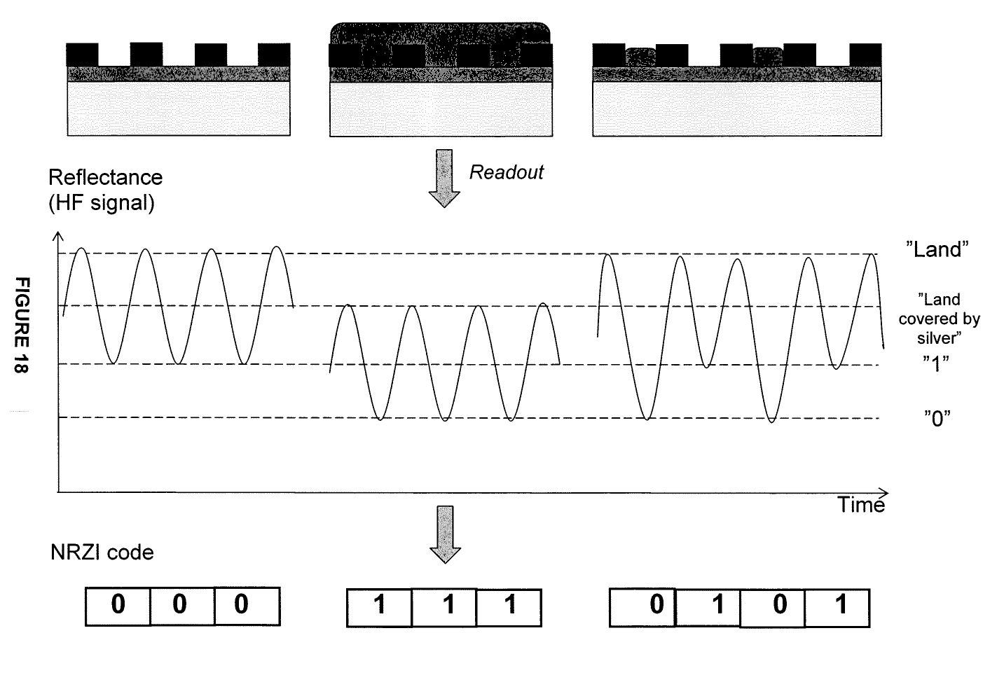

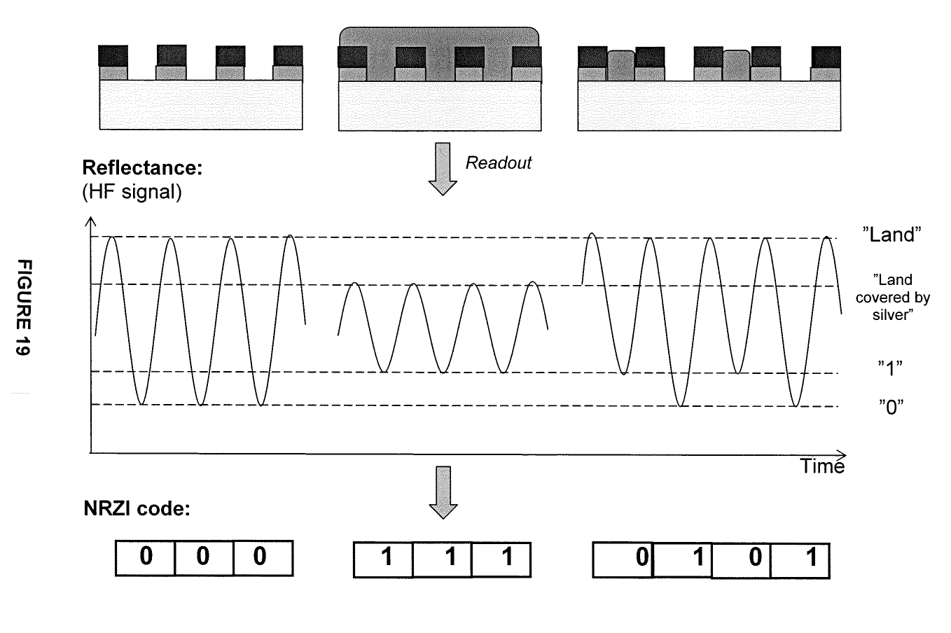

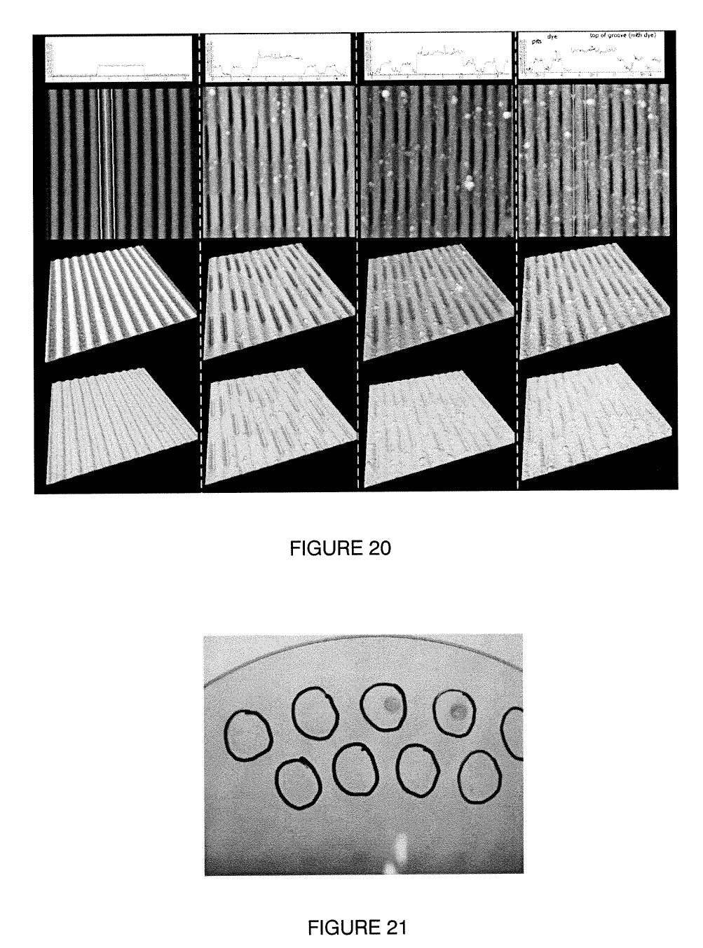

The result after the silver enhancement process on a disc with Ultragreen dye and pit features was also studied by atomic force microscopy (AFM) using a Dimension system from Veeco (FIG. 20). In addition to the optical microscopy observations, the AFM study reveals specific silver deposition at the positions of the biomolecules (SA-Au) after silver enhancement. In the AFM topographs, the silver appears as a granular matter, consisting of silver grains, and the silver grains are exclusively found after silver enhancement in the areas with SA-Au (FIG. 20 c, d).

With reference to FIG. 20 a) represents biomolecule incubation or silver enhancement treatment. The grooves in the disc can be seen and the dye coating is smooth. b) represents pits burnt in the grooves resulting in removal of the dye coating in the pits. This surface was not exposed to biomolecules or silver enhancement. c) represents an area with pits that were exposed to the silver enhancement solution but not incubated with SA-Au. No silver was detected. d)represents an area that was incubated with SA-Au and then exposed to the silver enhancement solution. The result of the treatment is a surface coated by small silver grains appearing as a rough background on the disc surface. The silver grains are covering both lands and pits.

Biomolecule 2: Multi-Biotinylated DNA Labeled with Streptavidin and 10-nm-Au-Particles

Streptavidin labeled with 10-nm-Au particles (Prod# S9059, Sigma) were coupled to multi-biotinylated DNA (DNA-SA-Au) using a standard coupling protocol and purification methods in biochemistry. First, the disc's dye coating was coated with poly-1-lysine (PLL) (Prod# P4832, Sigma) according to the supplier's recommendations, and then the DNA-SA-Au was incubated onto the PLL treated Ultragreen dye coating in the form of a 5 μl droplet with the concentration 1.8×10¹² molecules/ml. As negative control, the disc was incubated with 5 μl droplets of MilliQ water, multi-biotinylated DNA, and as positive control SA-Au solution was used. After incubating for 75 min, the disc was rinsed with MilliQ water and then dried. The disc was then treated with the silver enhancement solution for 20 min followed by rinsing and drying the disc. The silver enhancement process resulted in deposition of silver at the positions incubated with DNA-SA-Au (FIG. 21 c) and (FIG. 21 d), visible as grey stains with the shape of the incubation droplets. Silver deposition was not detected at the areas incubated with MilliQ water (FIG. 21 a) or multi-biotinylated DNA (FIG. 21 b).

### Example 3

### Etching of Reflector Through Pits Using Dye Coating and Silver as Etch Block

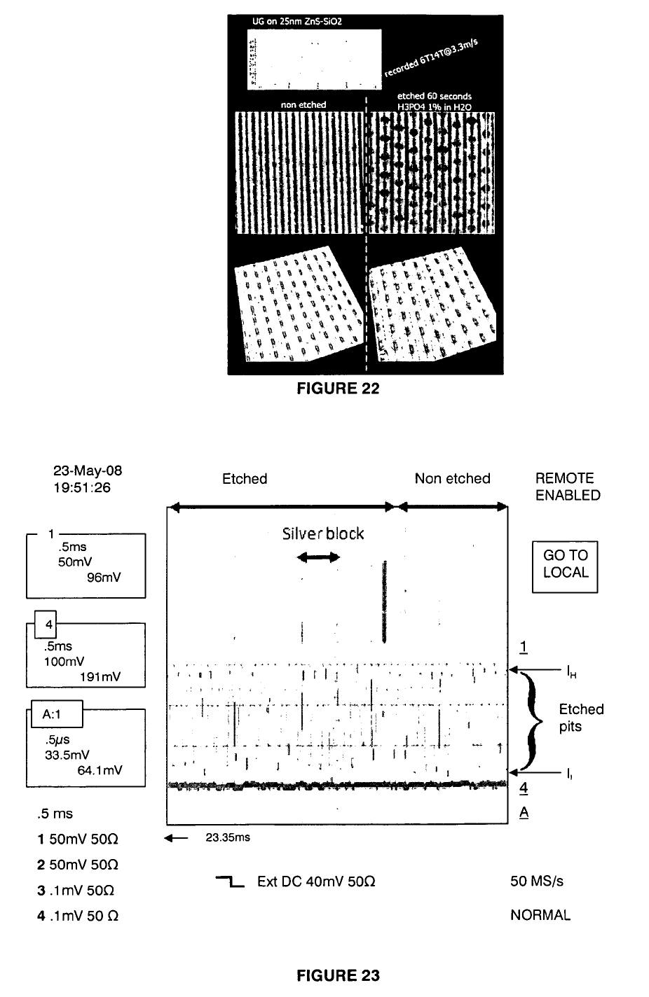

A disc with a HD DVD polycarbonate substrate, a 25-nm-thick ZnS—SiO₂ reflector and Ultragreen dye coating was first fabricated, using an optical disc production line and then patterned with pits. Pits were exposed using standard 6T pit pulses separated by 14T lands at half standard writing speed (0.5×, corresponding to 3.3 m/s), resulting in actual 3T pits separated by 7T lands. The pits, a result of local ablation, reaching through the dye coating, exposed the reflector underneath, making the reflector accessible for an etchant. For etching, the disc surface was exposed to a 1% H₃PO₄ solution for 60 s and then washed with MilliQ water and dried. AFM studies of the pits before and after etching show the removal of the dielectric reflector in the pits (FIG. 22) while the dye coating remains intact, acting as an etch mask.

Silver coatings similar to the one presented in FIG. 22 d were also exposed to the 1% H₃PO₄ etchant but no effect on the silver was detected by optical microscopy or AFM.

### Example 4

### Distinguishing Pits with and without Silver Deposition Using a Disc Drive

Alternative 1: Silver as Etch Block when Etching Reflector Through Un-Blocked Pits and Readout

A HD DVD polycarbonate substrate with 25-nm-thick ZnS—SiO₂ reflector and Ultragreen dye coating was fabricated and then patterned with pits. Pits were exposed using standard 6T pit pulses separated by 14T lands at half standard writing speed (3.31 m/s), resulting in 3T pits with 7T lands.

A droplet of SA-Au, approximately 2-3 mm in size (same conditions as in Example 2), was placed on the disc for locally attaching SA-Au to the disc surface. The droplet was left on the disc for 75 min and then washed away with MilliQ water and then dried.

The SA-Au coated area, as well as the surrounding area (several cm in size), was then treated with the silver enhancement solution for 20 min. The silver enhancement resulted in a visible deposition of silver in the areas with SA-Au.

The silver deposition was used as an etch block for preventing the etching of the reflector in the pits coated with silver. Etching was done over an area including the SA-Au, as well as the silver enhanced areas by covering the areas with the 1% H₃PO₄ etchant for 60 s. The disc was then rinsed with MilliQ water and dried.

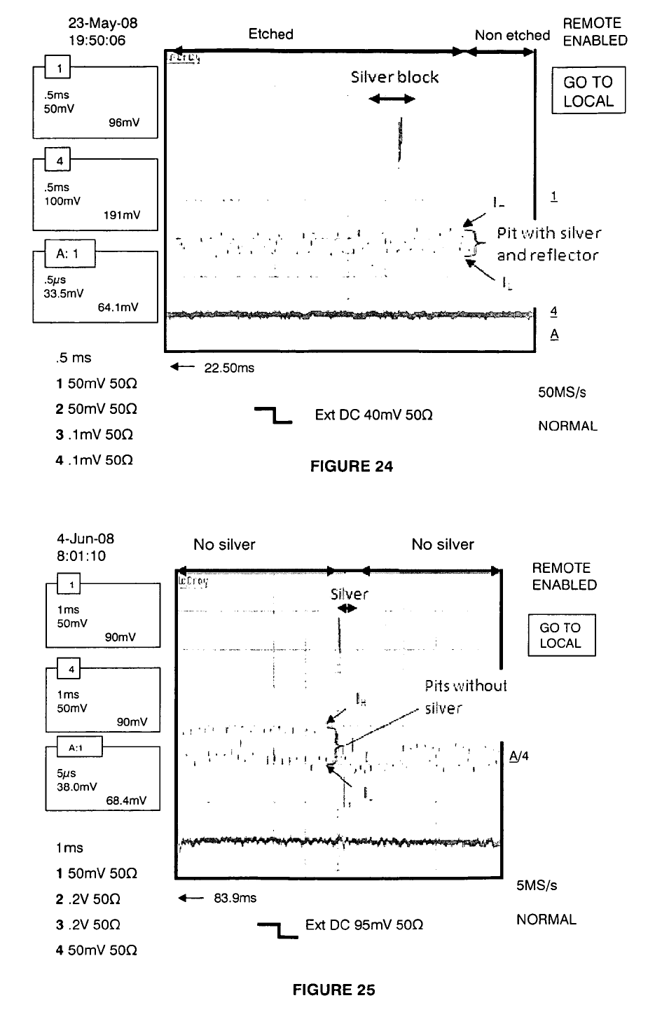

The reflectivity of the etched pits that were compared with pits blocked with silver using an ODU-1000 (Manual Type) Optical Disc Drive Unit (Pulstec Industrial, Co.) reading a track on the disc at normal speed (1×, corresponding to 6.61 m/s). The track reached through areas that were etched, areas with silver and areas without either etching or silver. First, the scope trace of the etched pits shows a clear decrease in reflectivity compared to pits with an intact dielectric reflector (non-etched) (FIG. 23). Further, the reflectivity from the lands covered with silver was lower compared to the reflectivity from lands not covered with silver FIG. 23. The sum-signals for FIGS. 23 and 24 are presented in Table 1, showing that pits with silver and pits without silver can be distinguished at the single pit level.

TABLE 1
Average sum signals from pits with etched reflector and
pits with silver block and intact reflector. The sum
decreases for both lands and pits when covered with silver.
Sum signals: Alternative 1

| Average sum | | Pits with silver |
|---|---|---|
| signal intensity | Etched pits | and reflector |
| I_{H} [mV] | 117 | 83 |
| I_{L} [mV] | 54 | 66 |

### Alternative 2: Silver Deposition on Intact Reflector

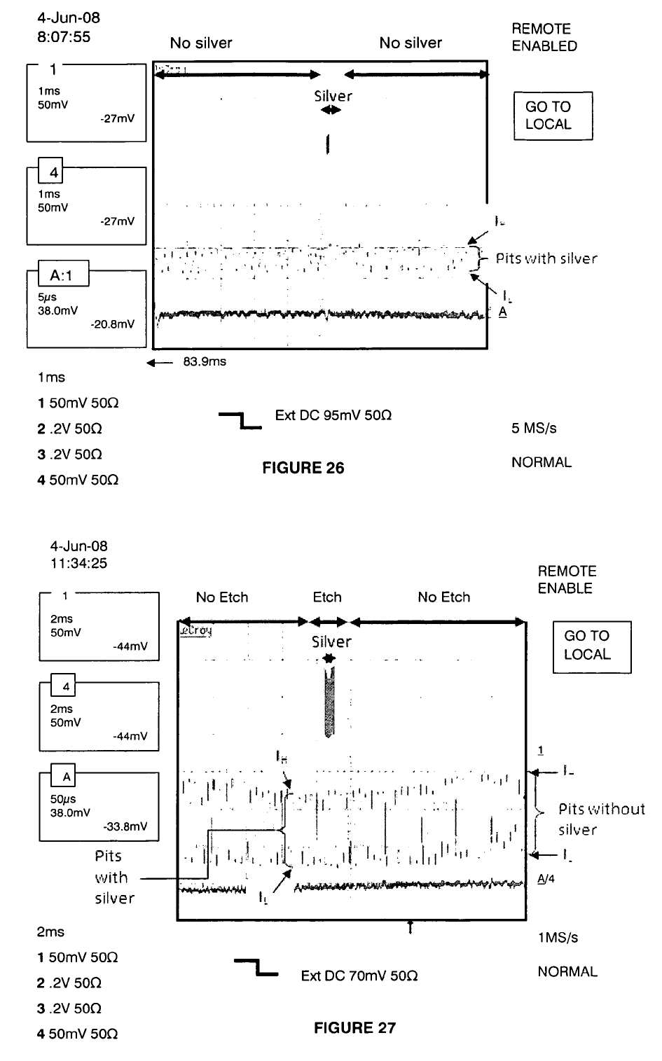

A disc with pits was prepared in the same way as in alternative 1, including SA-Au incubation and, subsequently, silver enhancement, excluding the etching process. The ODU-1000 (Manual Type) Optical Disc Drive Unit was used to collect reflection data from areas with silver deposition (FIG. 25) and without silver deposition (FIG. 26). The reflectivity decreases both in pits and lands when silver is added compared to the pits and lands without silver. The change in reflectivity, both on land and in pits, is detectable on a single land or pit level (FIGS. 25 and 26). The average sum signals pits and lands are presented in Table 2, showing that pits with silver and pits without silver can be distinguished at the single pit level.

TABLE 2
Sum signals from pits with intact reflector
with silver and without silver.
Sum signals: Alternative 2

| Average sum | Pits without | |
|---|---|---|
| signal intensity | silver | Pits with silver |
| I_{H} [mV] | 117 | 75 |
| I_{L} [mV] | 99 | 67 |

### Alternative 3: Etching of Reflector Before Incubation and Silver Deposition

A disc consisting of a polycarbonate substrate, reflector and dye coating with pits was prepared in the same way as described in alternative 1. The disc was then etched by adding 1% H₃PO₄ etchant solution to the disc surface for 60 s, similar to the method presented in FIG. 22, resulting in removal of the reflector in all the pits exposed to the etchant. A small area of the disc was then incubated with but with a 1 μl droplet of SA-Au solution, similar to the solution presented in alternative 1.

The ODU-1000 (Manual Type) Optical Disc Drive Unit was used to collect reflection data from areas with silver deposition and without silver deposition (FIG. 27). The reflectivity decreases both in pits and lands when silver is present on the surface compared to the pits and lands without silver. The change in reflectivity, both on land and in pits, is detectable on a single land or pit level (FIG. 27). The average sum signals from FIG. 27 are presented in Table 3, showing that pits with silver and pits without silver can be distinguished at the single pit level.

TABLE 3
Sum signals from pits, without reflector,
without silver and with silver.
Sum signals: Alternative 3

| Average sum | Pits without | |
|---|---|---|
| signal intensity | silver | Pits with silver |
| I_{H} [mV] | 117 | 75 |
| I_{L} [mV] | 99 | 67 |

1. An optically readable substrate comprising a transparent solid substrate and a layer of a compound, wherein the transparent substrate has an upper surface with a reflective material disposed thereon, and wherein the transparent substrate has an upper surface that can be ablated and that coats the top surface of the reflective material.

2. (canceled)

3. The substrate according to claim 1, wherein the compound is a dye.

4. (canceled)

5. The substrate according to claim 1, wherein pits are formed in the compound layer, wherein the reflective layer is exposed in the pits.

6. (canceled)

7. The substrate according to claim 5, wherein a polymer molecule is immobilized within one or more of the pits.

8. The substrate according to claim 7, wherein the polymer molecule is a polynucleotide.

9. The substrate according to claim 7, wherein the polymer molecule has an affinity partner bound thereto.

10-30. (canceled)

31. A method for determining one or more characteristics of a target molecule, said target molecule being localized on an optical substrate comprising pits and lands, said method comprising the steps of:
(i) carrying out one or more reactions to interrogate defined characteristics of the target molecule, wherein each of said reactions occurs in a distinct pit;
(ii) treating the optical substrate to modify either those pits where a reaction has occurred, or those pits where a reaction has not occurred, to alter the reflective characteristics of the pits; and
(iii) measuring reflectivity of the pits, to thereby determine the one or more different characteristics of the target molecule.

32. The method according to claim 31, wherein step (i) is carried out by reacting the target molecule with a second molecule that binds to the target molecule if the target molecule has a particular characteristic, localizing a metallic particle at or within the pit, and carrying out metallic enhancement to selectively deposit a metallic layer at or within those pits that contain the reacting molecules.

33. The method according to claim 31 wherein the optical substrate comprises a reflective layer at the bottom of the pits.

34. The method according to claim 33, wherein after step (ii) the reflective layer is removed in those pits where a reaction has occurred.

35. (canceled)

36. The method according to claim 31, wherein the optical substrate does not comprise a reflective layer at the bottom of the pits.

37. The method according to claim 31, wherein the target molecule is a polynucleotide.

38. The method according to claim 37, wherein the polynucleotide comprises a series of sequence units, each unit comprising a plurality of nucleotide sequences representing a specific characteristic.

39. The method according to claim 31, wherein the series of pits represent binary data.

40-68. (canceled)

69. A method for storing information on the characteristics of a polymer, comprising encoding an optically readable substrate with a series of optically readable structures which, together, identify a plurality of characteristics of the polymer.

70. The method according to claim 69, wherein the substrate comprises a reflective layer, and the optically readable structures are disruptions to the reflective layer.

71. The method according to claim 69, wherein the polymer is a polynucleotide having a series of defined sequence units of at least 2 nucleotides, wherein each sequence unit is encoded on the optically readable substrate.

72-75. (canceled)

76. The method according to claim 31, wherein the substrate is an optical disc.

77. The method according to claim 76, wherein the disc comprises multiple data tracks.

78-82. (canceled)

83. The method according to claim 69, wherein the substrate is an optical disc.
